(19) United States
(12) Patent Application Publication
(10) Pub. No.: US 2014/0176337 A1
(43) Pub. Date: Jun. 26, 2014

(54) SOLAR PANEL WIND TURBINE COMMUNICATION SERVER NETWORK APPARATUS METHOD AND MECHANISM

(71) Applicants: David Valin, Concord, CA (US); Alex Socolof, Briarcliff Manor, NY (US)

(72) Inventors: David Valin, Concord, CA (US); Alex Socolof, Briarcliff Manor, NY (US)

(21) Appl. No.: 13/721,116

(22) Filed: Dec. 20, 2012

(51) Int. Cl. G08C 19/00

(52) U.S. Cl. CPC G08C 19/00
USPC 340/870.02

(57) ABSTRACT

The method included herein is an alternative energy wireless solar panel wind turbine communication server appliance node mechanism with built in communications server array, wireless energy and communications mechanism with protection, sharing, storage, accessing, authentication, battery management, certification, processing attachment and tracking mechanisms. The method and mechanism is utilized via networked servers, solar panels, and wireless electronic devices (online and offline) as well as mobile (wireless) communications devices built into one waterproof, temperature, controlled self-sensing hardware package. The method and mechanism also works as part of a kilowatt hour banking system, and thermal passive solar control mechanism for living spaces.

### CROSS REFERENCE TO RELATED APPLICATIONS

This application claims priority from and is a continuation of U.S. patent application Ser. No. 12/768,981, entitled “SOLAR PANEL WIND TURBINE COMMUNICATION SERVER NETWORK APPARATUS METHOD AND MECHANISM”, filed on Apr. 28, 2010, which is incorporated by reference in its entirety for all purposes as if fully set forth herein.

### SEQUENCE LISTING OR PROGRAM

Not Applicable

### FEDERALLY SPONSORED RESEARCH

Not Applicable

### TECHNICAL FIELD OF THE INVENTION

The present invention relates to an independent solar panel wind turbine communication server appliance network of nodes connected together to form a powerful energy network for communications and energy needs. The method and mechanism system has several remote management aspects plus a special metering system for kilowatt hours and thermal temperatures.

### BACKGROUND OF THE INVENTION

The use of solar panels for daylight energy creation is very wide spread, and has limited intelligence included into the solar panel design; if inclement weather is presented the energy creation is limited and can limit power generation for long periods of time.

### DEFINITIONS

A “human key” is a software identification file that enables a user to verify themselves to another user or a computer system. The software file of the human key enables a user to be verified and/or authenticated in a transaction and also provides tracking of the financial transaction by associating the transaction to one or more human keys which identify and authenticate a user in the system.

A “QR Code”, abbreviated from and also known as “Quick Response Code”, is defined as a type of matrix barcode, or two-dimensional code, used for commercial tracking, entertainment and transport ticketing, product marketing, and in-store product labeling.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

A “mobile device” is a generic term used to refer to a variety of devices that allow people to access data and information from where ever they are. This includes cell phones and other portable devices such as, but not limited to, PDAs, Pads, smartphones, and laptop computers.

“NFC” is an acronym for “Near Field Communication” which allows for simplified transactions, data exchange, and wireless connections between two devices in proximity to each other, usually by no more than a few centimeters. NFC is expected to become a widely used system for making payments by smartphone in the United States. Many smartphones currently on the market already contain embedded NFC chips that can send encrypted data a short distance (“near field”) to a reader located, for instance, next to a retail cash register. Shoppers who have their credit card information stored in their NFC smartphones can pay for purchases by waving their smartphones near or tapping them on the reader, rather than using the actual credit card.

“Social network sites” are web-based services that allow individuals to (1) construct a public or semi-public profile within a bounded system, (2) articulate a list of other users with whom they share a connection, and (3) view and traverse their list of connections and those made by others within the system. The nature and nomenclature of these connections may vary from site to site. While we use the terms “social network”, “social network pages”, and “social network site” to describe this phenomenon, the term “social networking sites” also appears in public discourse, and the variation of terms are often used interchangeably.

### SUMMARY OF THE INVENTION

The present method and mechanism of this invention, the solar panel wind turbine communication server appliance network nodes presented here meets the needs of the alternative energy user by providing many additional positive features, to reduce the energy cost for the user and reduce drain on the conventional energy grid by the user, plus added features for the user to be able to have an additional source of power, and communication just in case the traditional energy grid goes down. Some of the features include heat generation cover for cooling or heating the solar server node, and in combination with many nodes, the average amount per home would be 16 to 48 for homes and more for open spaces and commercial properties, the method and mechanism can heat a whole structure, generate energy for cooling, and has low energy solar server units that can be used for communications, data processing, entertainment, and anything else a family might want major supercomputing parallel processing power for. The user can have a plurality of devices in their structure connected into the solar server node system and they can have the power of a supercomputer at their disposal.

The communication mechanism has a voice over internet protocol server, where a special wireless handheld device, or mobile phone can be used with each structure solar server cluster of nodes, and can be connected to the main backbone of the internet, as well as connected locally to neighbors solar server clusters in a local network. The business method for the distribution of the mechanism is flexible and is built around either a no cost setup and installation with payments balanced with the amount of energy consumed as time goes by on the contract, or combination lease purchase or installment method.

A solar server automatic cleaner mechanism is included, to automatically remove snow, and rain from the surface of the solar cells to keep them running in inclement weather, also there is a plurality of retractable wind turbines that generate energy at night and during inclement weather when the solar panels cannot generate energy.

A wireless energy transference method and mechanism is used to boost the collective energy of the cluster grid, and ultimately pass it along even in inclement weather for use by the user or other network users, store it, and/or send it along to the traditional grid, or grid network for kilowatt hour storage in a banking system.

A metering system is connected to a kilowatt hour bank that keeps track of users kilowatt hours used, and the excess energy used by a user or group of users, energy used by individual mechanisms, and energy sent to storage or the power grid, and whenever energy is stored and/or banked, the excess energy can be traded for tangible assets, including goods and services.

The present invention also has a triple solar, wind, magnetic electricity generation system that has the capability to be automatically adjusted for optimum energy generation.

The present invention includes special heat thermal sensors that detect, bad components, and heat pockets for the automatic cooling mechanism to address and cool down those areas included in this comprehensive energy solar server node mechanism.

Each solar server node has its own independent wireless router for communications transfers or to each node in the cluster, and to the outside network, in addition the plurality of routers allow for connectivity to any space including living spaces, and provide fast connections for resource intensive uses, such as VOIP video conferences that run better due to the parallel processing of the data flow through the independent wireless router cluster network.

In addition the present invention includes passive heat generated from the winter cover system mechanism for protection of each solar server node, for heating and melting snow, and generating additional energy in the form of heat, and electricity, utilizing the double redundancy magnetic motor fan engine mechanism, and food can be cooked in a specially developed solar forced air convection oven, and mechanism can also heat a space, and at night with the wind turbines electricity generator mechanism can keep an ambient temperature throughout the night, while generating energy to keep batteries charged, and depositing surplus amounts of kilowatt hours into an energy bank, or charging any electric, and/or mobile device automatically.

The present invention also provides for an alarm system mechanism that never stops as its power lines cannot be cut.

Also the present invention provides for a magnetic tagging system for managing every square inch of a building structure, or contents in building structure through the solar server node network, so that when an object is moved or transported the system can track the object as long as it stays within the solar server communication network grid, and it also can be connected to external camera systems to track an object within network system range, and actually track the object through the area of the local network of user structures, until the object leaves the network area.

Also the present invention provides for a multiple redundant solar panel wind turbine communication server appliance node, and cluster networks with backup and storage method, and mechanism, used for important data storage, and events management, and when clustered in a parallel processing network creates high speed data processing and supercomputer access at each location.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique.

FIG. 1 illustrates Solar panel wind turbine communication server appliance node Wireless Energy Aggregation Method and Mechanism;

FIG. 2 illustrates Dual Node Solar panel wind turbine communication server appliance node Network Aggregation Mechanism;

FIG. 3 illustrates Prot 1 Phrase Analysis and Recognition Mechanism;

FIG. 4 illustrates Solar panel wind turbine communication server appliance node Wireless Energy Aggregation Mechanism Battery Storage Mechanism;

FIG. 5 illustrates Solar panel wind turbine communication server appliance node Winter Heating Apparatus with Cleaner Mechanism;

FIG. 6 illustrates Solar panel wind turbine communication server appliance node Winter Heating Unit Mechanism;

FIG. 7 illustrates Solar panel wind turbine communication server appliance node Wireless Energy Transfer Mechanism and Cleaner Apparatus;

FIG. 8 illustrates Solar panel wind turbine communication server appliance node Cleaner Mechanism;

FIG. 9 illustrates Solar panel wind turbine communication server appliance node Wind Turbine Mechanism;

FIG. 10 illustrates Cooling Mechanism Solar panel wind turbine communication server appliance nodes in cluster mechanism;

FIG. 11 illustrates Solar panel wind turbine communication server appliance node Wireless Communication Mechanism;

FIG. 12 illustrates Solar panel wind turbine communication server appliance node Wireless Communication Mechanism;

FIG. 13 illustrates Solar panel wind turbine communication server appliance node Wiring Mechanism;

FIG. 14 illustrates Solar panel wind turbine communication server appliance node Magnetic Motor Fan Mechanism;

FIG. 15 illustrates Solar panel wind turbine communication server appliance node Wind Turbine Mechanism;

FIG. 16 illustrates Solar panel wind turbine communication server appliance node Security Cam and Thermal Belt Sensing Mechanism;

FIG. 17 illustrates Solar panel wind turbine communication server appliance node Security Cam and Thermal Belt Mechanism;

FIG. 18 illustrates Solar panel wind turbine communication server appliance node VOIP Wireless Device Mobile Mechanism;

FIG. 19 illustrates Mini Wind Turbine Solar panel wind turbine communication server appliance node Retract Mechanism;

FIG. 20 illustrates Solar panel wind turbine communication server appliance node used to enhance devices in space;

FIG. 21 illustrates Solar panel wind turbine communication server appliance node Energy Bank Mechanism;

FIG. 22 illustrates Solar panel wind turbine communication server appliance node Retractable Cleaner Mechanism;

FIG. 23 illustrates Solar panel wind turbine communication server appliance node to Energy Bank Mechanism;

FIG. 24 illustrates Solar panel wind turbine communication server appliance node network cooling and super heating pipe mechanism;

FIG. 25 illustrates Solar panel wind turbine communication server appliance node network cooling and super heating magnetic motor fan mechanism;

FIG. 26 illustrates Solar panel wind turbine communication server appliance node Automatic Protection Cover and Heat Generator Mechanism;

FIG. 27 illustrates Solar panel wind turbine communication server appliance node Network Battery Management Mechanism;

FIG. 28 illustrates Solar panel wind turbine communication server appliance node audio to human ear and mobile receiver targeted zones mechanism;

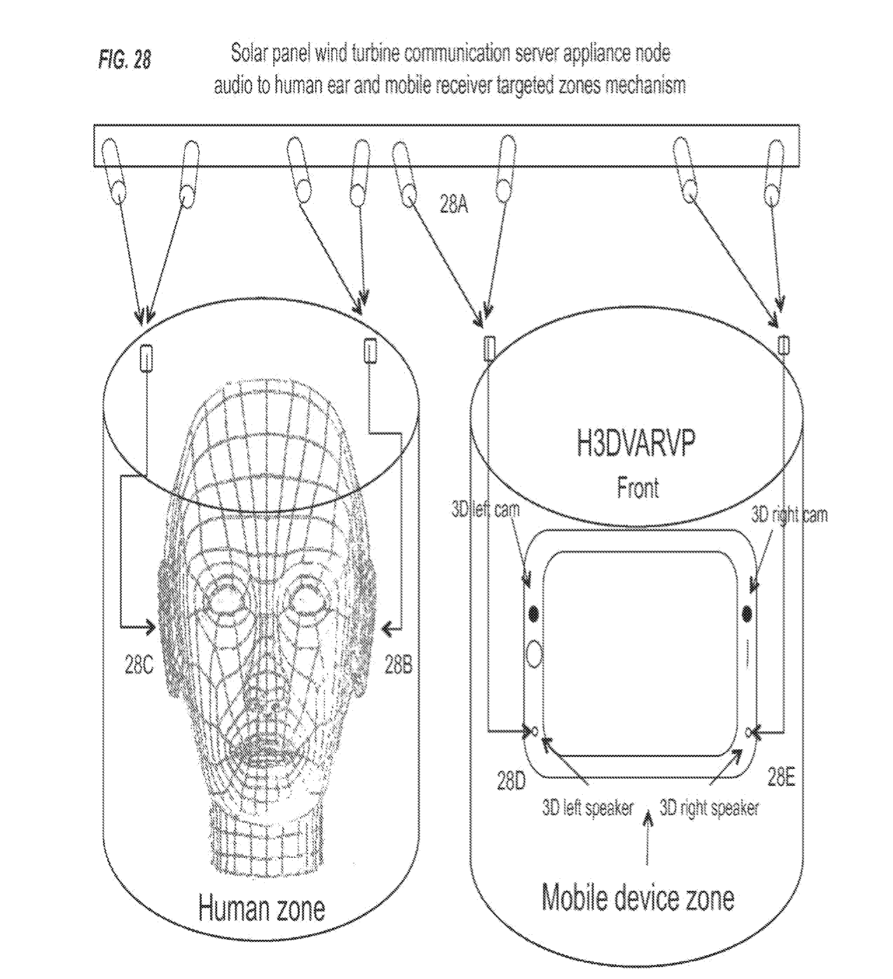

FIG. 29 illustrates Solar panel wind turbine communication server appliance node;

FIG. 30 illustrates Solar panel wind turbine communication server appliance node network infrared laser light waves transformed to audio sound waves at spatial point target zone;

FIG. 31 illustrates Solar panel wind turbine communication server appliance node Kilowatt Hour Bank payment system mechanism, with Protect Anything Human Key Identification Mechanism and the Kilowatt Hour mechanism pricing comparison;

FIG. 32 illustrates Solar panel wind turbine communication server appliance node H3DVARVP Protect Anything Human Key Identification Mechanism;

FIG. 33 illustrates Solar panel wind turbine communication server appliance node H3DVARVP mechanism with Protect Anything Human Key Identification Mechanism, and Virtual Augmented Reality Data Mechanism;

FIG. 34 illustrates Solar panel wind turbine communication server appliance node Protect Anything Human Key 3D Human Video Audio Stereo Viewing and Recording Internal Mechanism;

FIG. 35 illustrates Solar panel wind turbine communication server appliance node Protect Anything Human Key 3D Human Video Audio Stereo Viewing and Recording Independent Mechanism;

FIG. 36 illustrates Protect Anything Human Key 3D Human Video Audio Stereo Viewing and Recording Mechanism;

FIG. 37 illustrates Solar panel wind turbine communication server appliance node retractable wind turbine generator mechanism;

FIG. 38; illustrates Solar panel wind turbine communication server appliance node retractable wind turbine generator mechanism; and

FIG. 39 illustrates Solar panel wind turbine communication server appliance node Retractable wind turbine generator mechanism.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

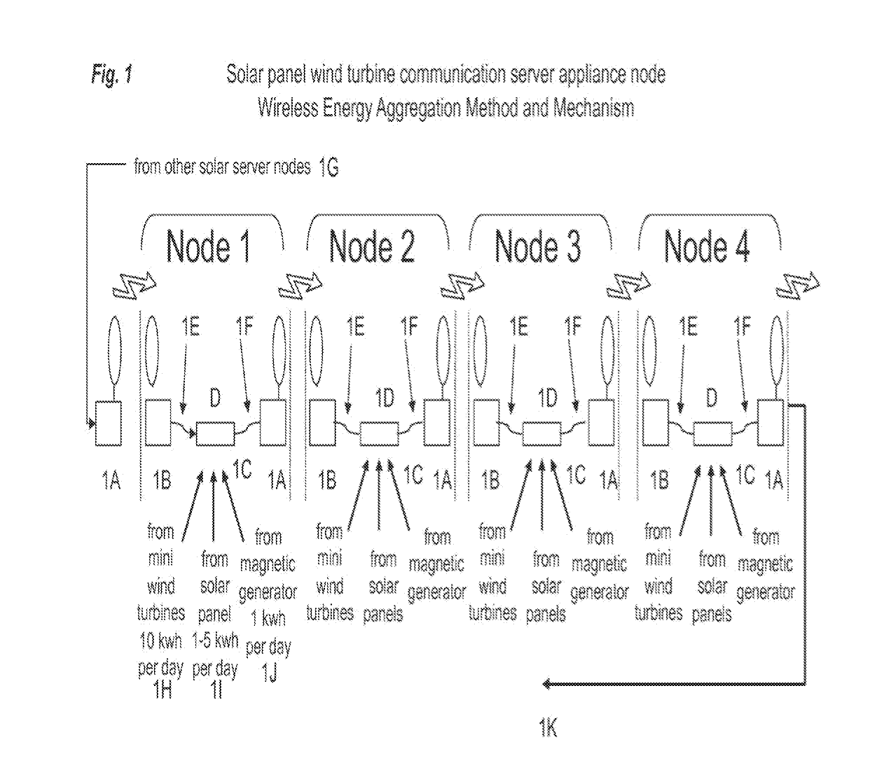

FIG. 1 is a conceptual diagram representative of wireless energy aggregation method and mechanism. Element 1A is a conceptual diagram representative of wireless electricity transmitter apparatus. Element 1B is a conceptual diagram representative of wireless electricity receiver apparatus. Element 1C is a conceptual diagram representative of wireless electricity energy bank meter apparatus. Element 1D is a conceptual diagram representative of wireless electricity transformer apparatus. Element 1E is a conceptual diagram representative of wireless electricity flow from receiver to transformer apparatus. Element 1F is a conceptual diagram representative of wireless electricity flow from transformer to transmitter apparatus. Element 1G is a conceptual diagram representative of wireless electricity flow from other server nodes to transmitter apparatus. Element 1H is a conceptual diagram representative of electricity from mini wind turbines approximately 10 kilowatt hours per day. Element 1I is a conceptual diagram representative of electricity from solar panel approximately 15 kilowatt hours per day. Element 1J is a conceptual diagram representative of electricity from magnetic generator approximately 1 kilowatt hours per day. Element 1K is a conceptual diagram representative of electricity flow to other solar panel wind turbine communication server appliance nodes, and/or lower living zones for use of electricity or storage in batteries, or sold to conventional grid, or added to the energy bank for use later.

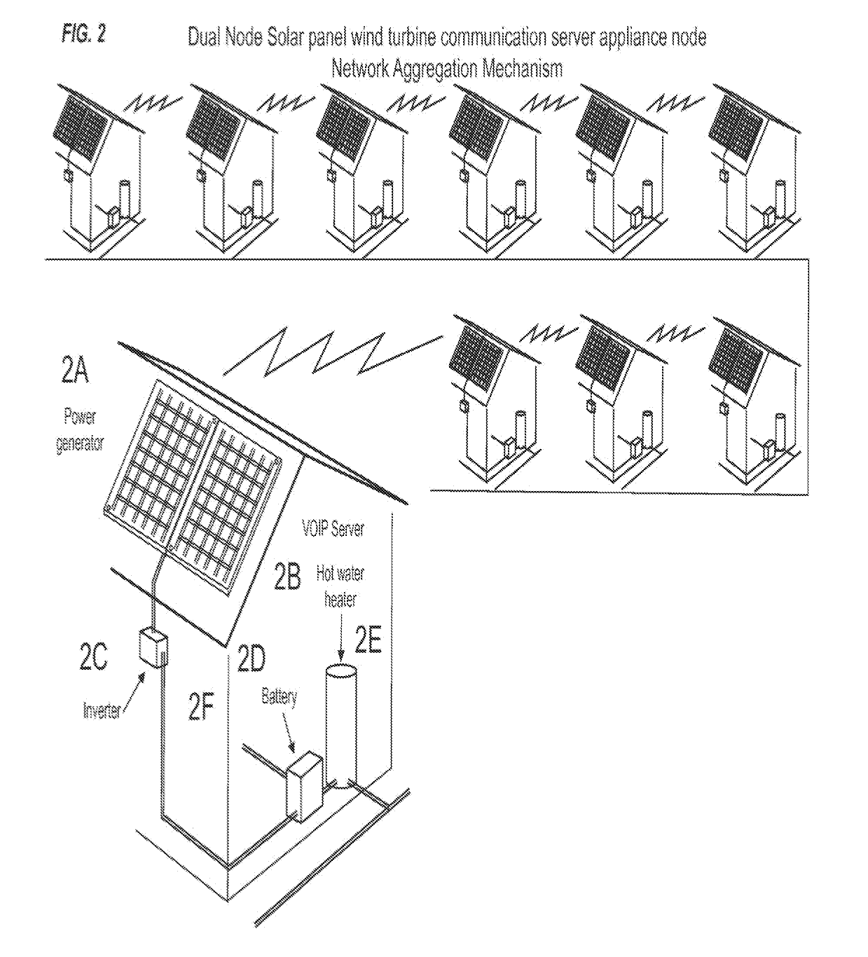

FIG. 2 is an illustration representative of the dual node solar server network aggregation mechanism demonstrating a plurality of nodes that are a cluster and that if the power and communication grid go down the system can communicate and get power from the other members of the solar server network grid wirelessly. Element 2A is an illustration representative of the power generator terrestrial based solar panel wind turbine communication server appliance node. Element 2B is an illustration representative of the power solar server with the VOIP server. Element 2C is an illustration representative of the inverter connected to the terrestrial based solar panel wind turbine communication server appliance node panels alternating current. Element 2D is an illustration representative of the battery connected to the inverter unit of the terrestrial based solar panel wind turbine communication server appliance node panels. Element 2E is an illustration representative of the hot water heater connected to the passive terrestrial based solar panel wind turbine communication server appliance node cooling venting mechanism. Element 2F is an illustration representative of the direct current connection to the battery from the terrestrial based solar panel wind turbine communication server appliance node panels.

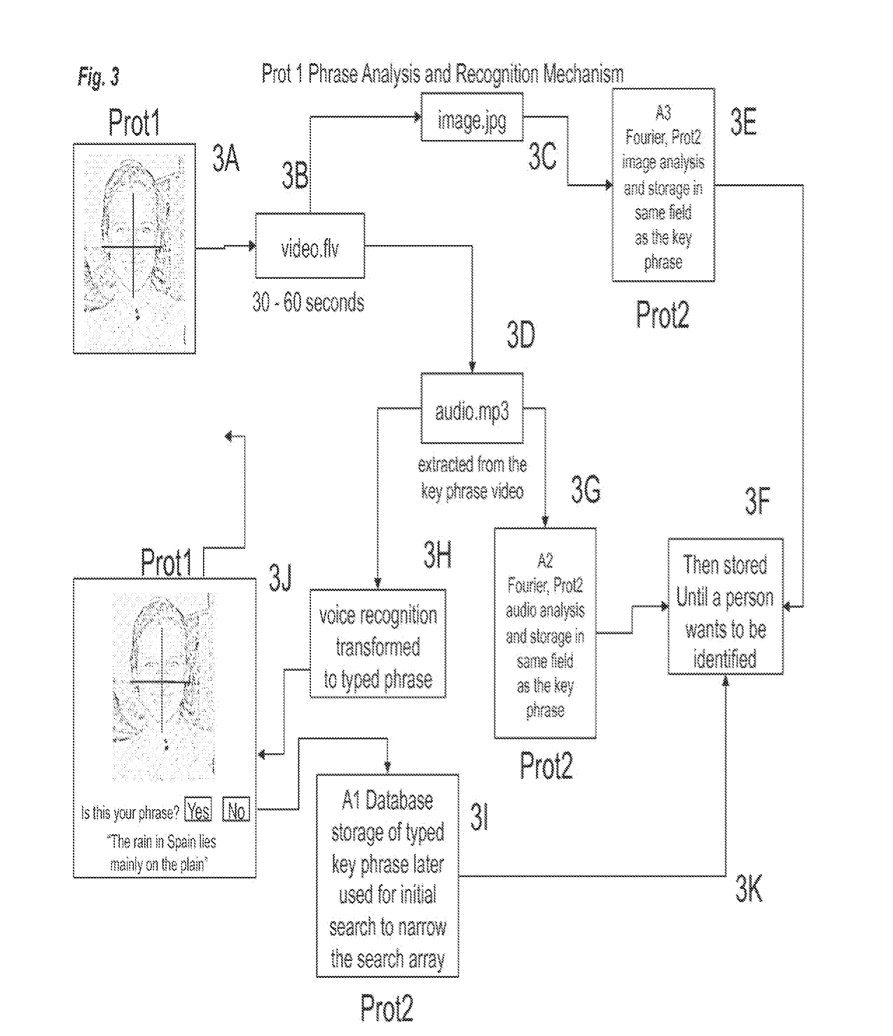

FIG. 3 is a block diagram illustrating a method and mechanism and mechanism for phrase analysis and human recognition as part of an embodiment of the present invention. Element 3A is a block diagram illustrating an enrollment method and mechanism with Prot 1, saying favorite key phrase while nose is on target cross hair of screen from cam. Element 3B is a block diagram illustrating an extraction of a video flv that is the length of 30 to 60 seconds. Element 3C is a block diagram illustrating an extraction of 300 images for analysis from the key phrase video. Element 3D is a block diagram illustrating an extraction of audio from the key phrase video. Element 3E is a block diagram illustrating a Fourier, Prot2, transformation from image.jpg file for analysis and storage in the same field as the key phrase for further processing. Element 3F is a block diagram illustrating that the data is then stored in a database until a person wants to be identified. Element 3G is a block diagram illustrating a Fourier, Prot2, transformation from audio.mp3 file for analysis and storage in the same field as the key phrase for further processing. Element 3H is a block diagram illustrating a voice recognition mechanism that takes voice and converts it to typed phrase. Element 3I is a block diagram illustrating a database storage mechanism of typed key phrase that is later used for the initial search, to narrow the search array. Element 3J is a block diagram illustrating the Prot 1 mechanism where a user is asked to say a phrase then verify that the typed phrase is the one that was said by the user yes or no and enrollment begins when the user presses yes and all of the audio, video, image, transformations of data, and the text data is stored for future comparison and identification. Element 3K is a block diagram illustrating the enrollment and verification with other verification method and mechanisms that can be added to the enrollment mechanism like driver's license, credit card data, birth certificate, and social security number.

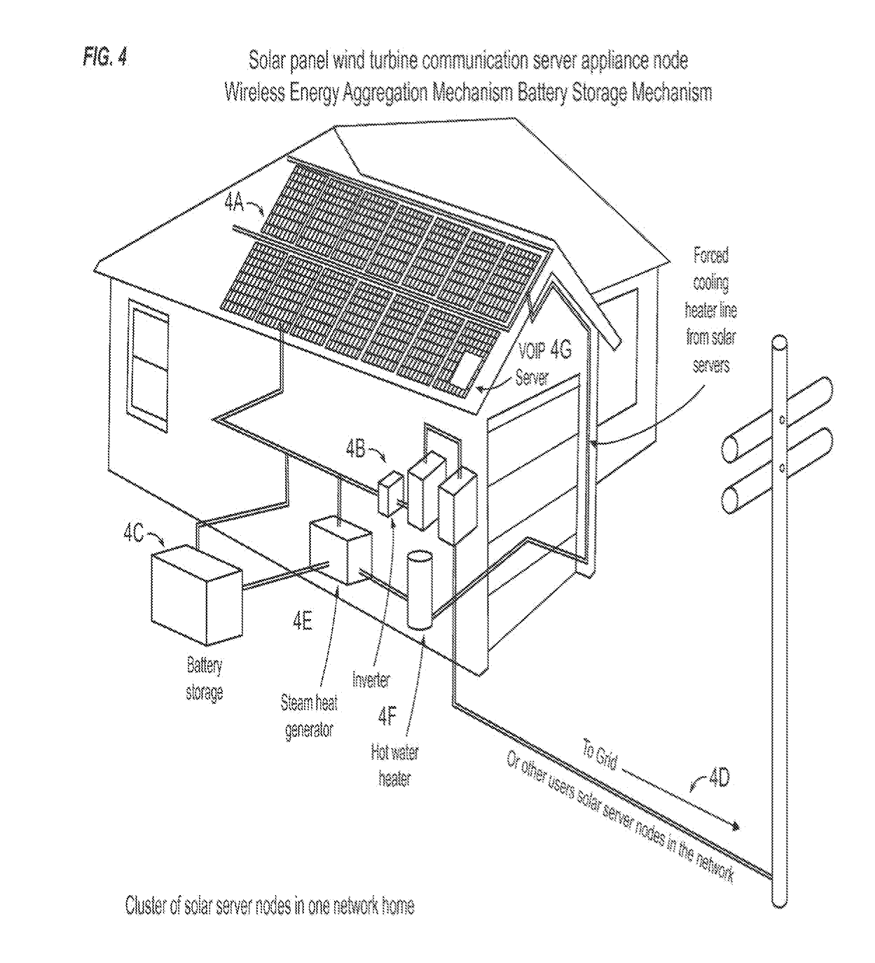

FIG. 4 is conceptual diagram illustrating a method and mechanism for the wireless energy aggregation mechanism battery storage mechanism an embodiment of the present invention. Element 4A is conceptual diagram illustrating a method and mechanism that shows terrestrial based solar panel wind turbine communication server appliance node cluster with cooling vent clear top black pipe heat transformation system which is an embodiment of the present invention. Element 4B is conceptual diagram illustrating a method and mechanism that shows DC voltage converted to AC with inverter in an embodiment of the present invention. Element 4C is conceptual diagram illustrating a method and mechanism that shows the battery storage system in an embodiment of the present invention. Element 4D is conceptual diagram illustrating a method and mechanism that shows the extra energy passing to the traditional power grid or to other user's terrestrial based solar panel wind turbine communication server appliance nodes in the network in an embodiment of the present invention. Element 4E is conceptual diagram illustrating a method and mechanism that shows the passive solar heat venting tube from the terrestrial based solar panel wind turbine communication server appliance nodes connecting to the steam heat generator in an embodiment of the present invention. Element 4F is conceptual diagram illustrating a method and mechanism that shows the passive solar heat venting tube from the terrestrial based solar panel wind turbine communication server appliance nodes connecting to the solar hot water heater in an embodiment of the present invention. Element 4G is conceptual diagram illustrating a method and mechanism that shows the terrestrial based solar panel wind turbine communication server appliance node voice over internet protocol server in an embodiment of the present invention.

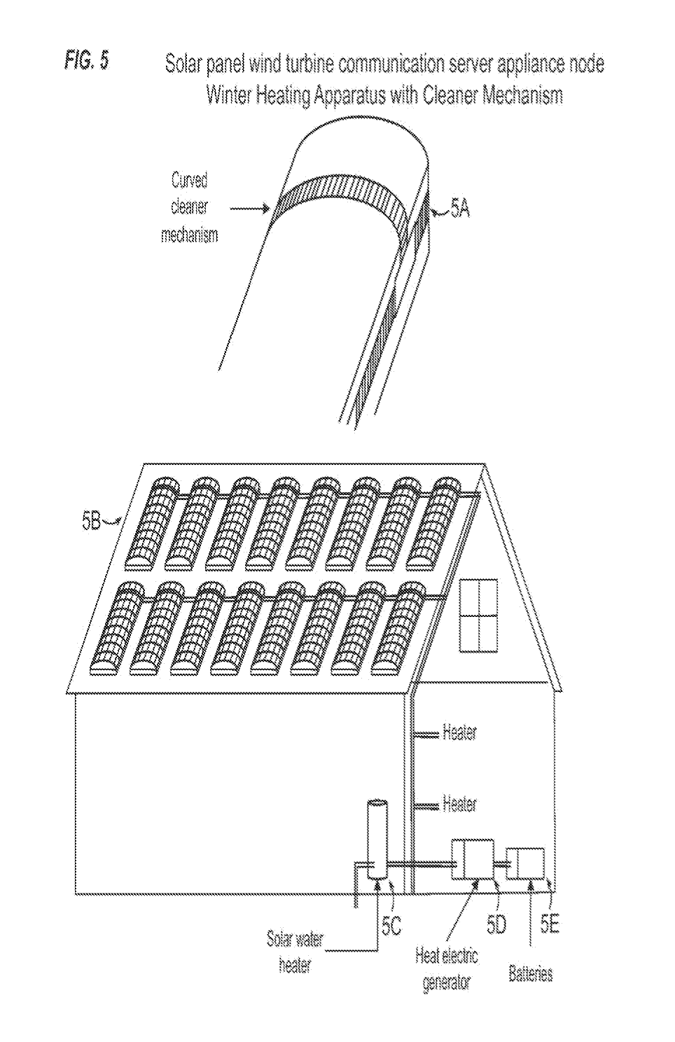

FIG. 5 is a conceptual diagram illustrating a method and mechanism that shows the solar server winter heating apparatus with cleaner mechanism in another embodiment of the present invention Element 5A is a conceptual diagram illustrating a method and mechanism that shows the curved cleaner mechanism according to another embodiment of the present invention. Element 5B is a conceptual diagram illustrating a method and mechanism that shows the clear dome winter attachments attached to the solar panel wind turbine communication server appliance node cluster and connected to the passive solar heating pipes according to another embodiment of the present invention Element 5C is a conceptual diagram illustrating a method and mechanism that shows the passive solar heating pipes connected to the solar water heater according to another embodiment of the present invention. Element 5D is a conceptual diagram illustrating a method and mechanism that shows the passive solar heating pipes connected to heat electric generator according to another embodiment of the present invention. Element 5E is a conceptual diagram illustrating a method and mechanism that shows the batteries connected to the heat electric generator according to another embodiment of the present invention.

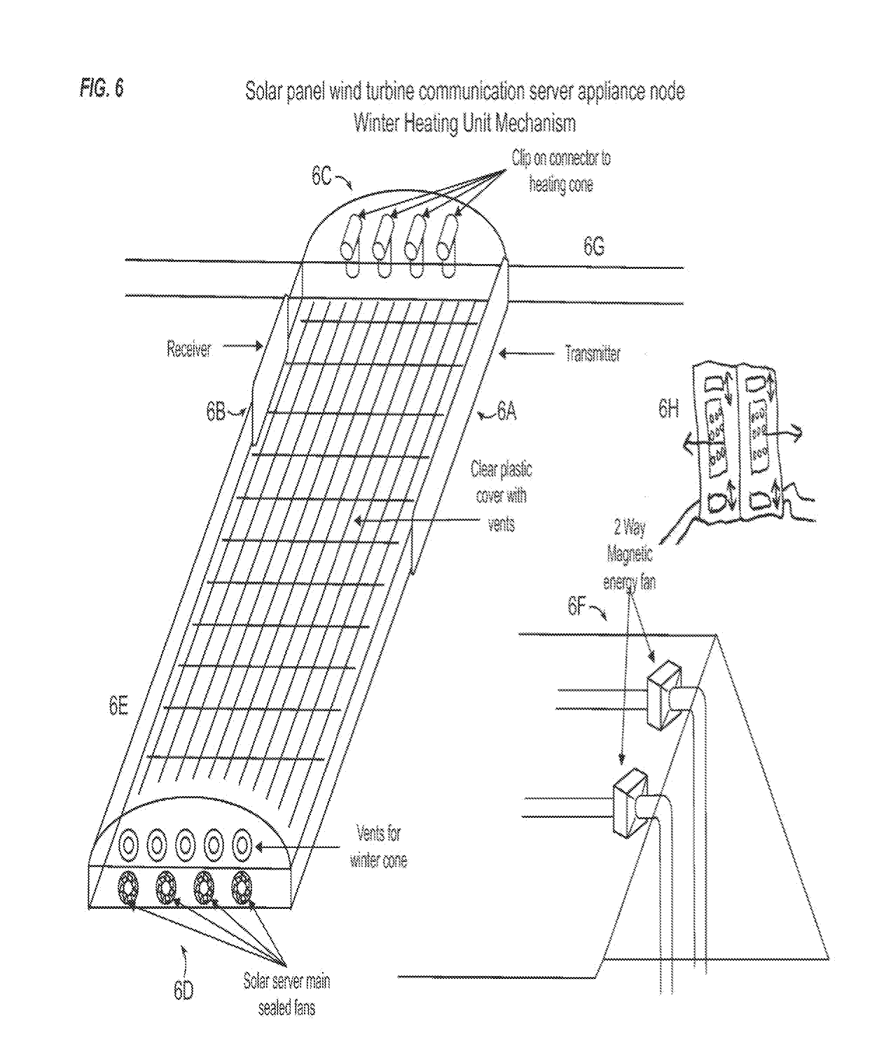

FIG. 6 is a conceptual diagram illustrating a method and mechanism that shows the terrestrial based solar panel wind turbine communication server appliance node winter heating unit mechanism in another embodiment of the present invention. Element 6A is a conceptual diagram illustrating a method and mechanism that shows the wireless energy transmitter in another embodiment of the present invention. Element 6B is a conceptual diagram illustrating a method and mechanism that shows the wireless energy receiver in another embodiment of the present invention. Element 6C is a conceptual diagram illustrating a method and mechanism that shows the venting unit mechanism of the terrestrial based solar panel wind turbine communication server appliance node clear winter cone cover apparatus in another embodiment of the present invention. Element 6D is a conceptual diagram illustrating a method and mechanism that shows the terrestrial based solar panel wind turbine communication server appliance node main sealed air input fans in another embodiment of the present invention. Element 6E is a conceptual diagram illustrating a method and mechanism that shows the intake vents for the winter cone cover in another embodiment of the present invention. Element 6F is a conceptual diagram illustrating a method and mechanism that shows the terrestrial based solar panel wind turbine communication server appliance node vent pipe connected to the passive solar 2 way magnetic energy fan in another embodiment of the present invention. Element 6G is a conceptual diagram illustrating a method and mechanism that shows the vent pipe from the terrestrial based solar panel wind turbine communication server appliance nodes in another embodiment of the present invention. Element 6H is a conceptual diagram illustrating a method and mechanism that shows the 2 way magnetic motor with stator turn offs and electric override mechanism from the terrestrial based solar panel wind turbine communication server appliance nodes in another embodiment of the present invention.

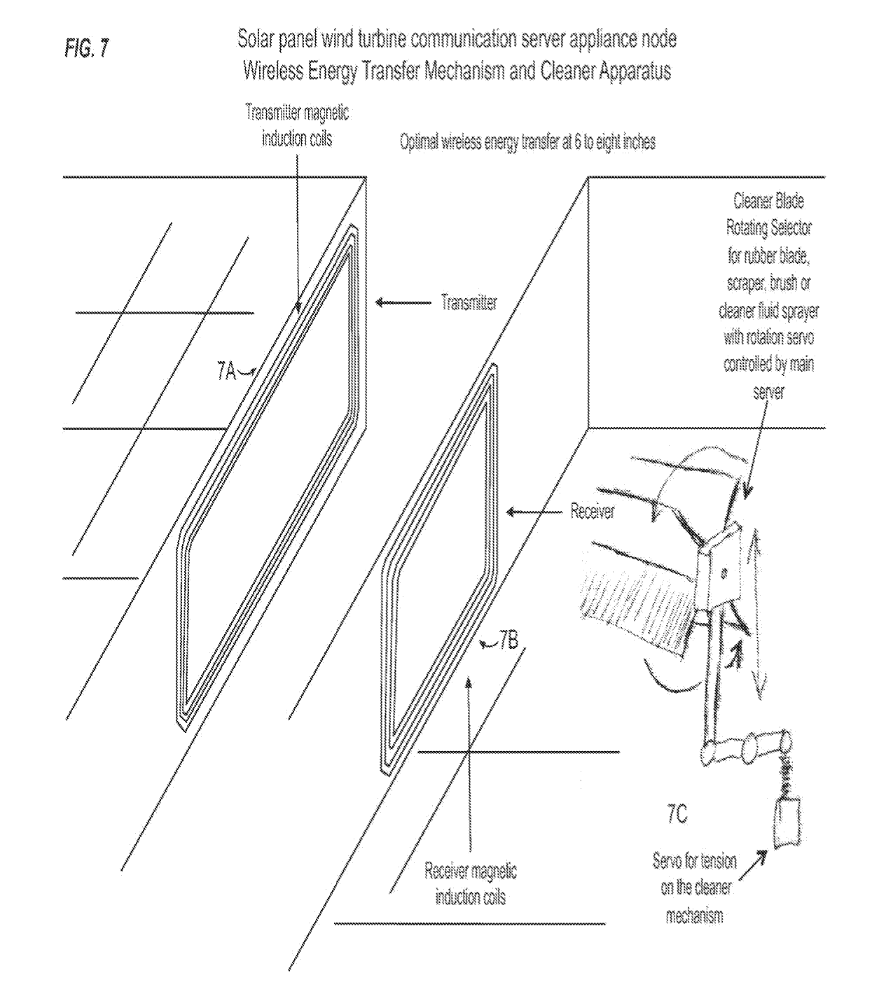

FIG. 7 is a cross sectional diagram of apparatus according to one embodiment of the present terrestrial based solar panel wind turbine communication server appliance node invention having a wireless energy transfer mechanism. Element 7A is a cross sectional diagram of transmitter magnetic induction coil apparatus according to one embodiment of the present invention having a Element 7B is a cross sectional diagram of receiver magnetic induction coil apparatus according to one embodiment of the present invention having Element 7C is a cross sectional diagram of solar panel wind turbine communication server appliance node tension and rotational blade apparatus for cleaner unit in one embodiment of the present invention having an electronic method for selecting which blade is necessary for the specific task and applying the right tension for effectiveness in cleaning

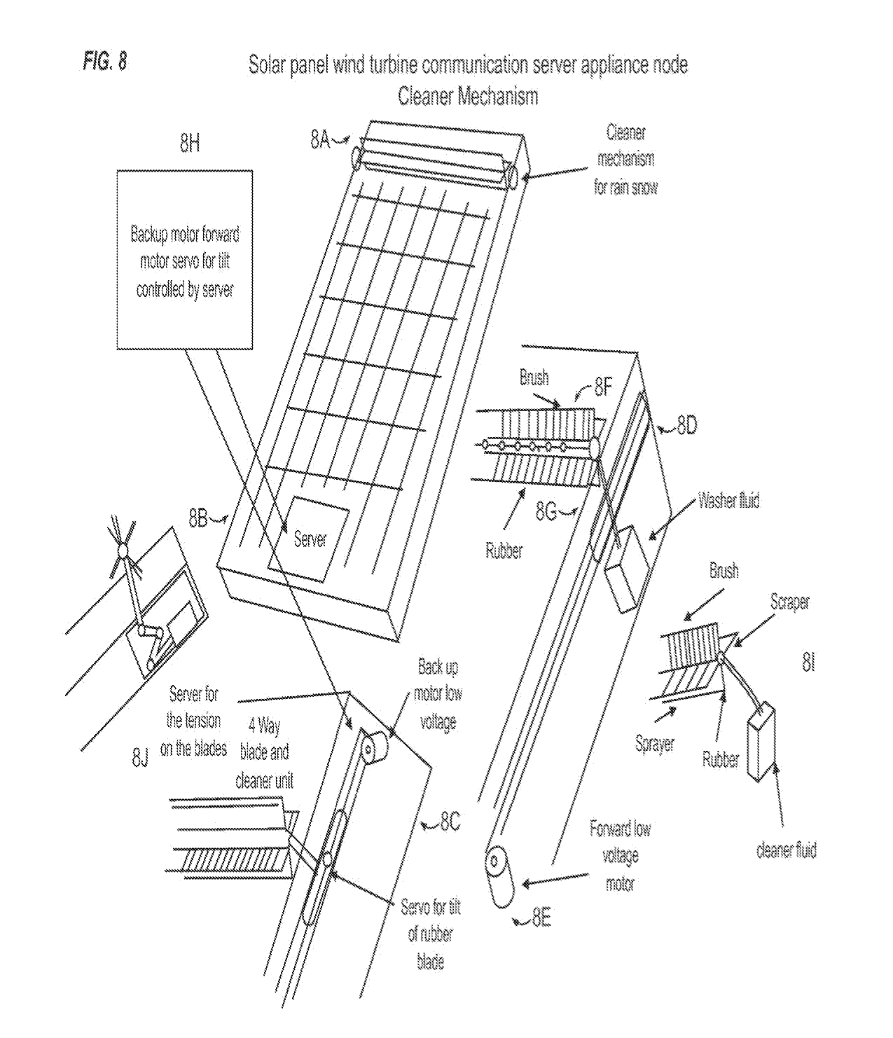

FIG. 8 is a conceptual diagram illustrating the terrestrial based solar panel wind turbine communication server appliance node cleaner mechanism Element 8A is a conceptual diagram illustrating cleaner mechanism for rain and snow. Element 8B is a conceptual diagram illustrating main terrestrial solar panel wind turbine communication server appliance node server for control of the backup motor and forward motor servo for tilt controller. Element 8C is a conceptual diagram illustrating low voltage backup motor and servo for rotation and tilt of 4 way blade and sprayer unit. Element 8D is a conceptual diagram illustrating sliding track for the movement up and down of the cleaner mechanism. Element 8E is a conceptual diagram illustrating forward low voltage motor. Element 8F is a conceptual diagram illustrating brush blade of 4 way cleaner unit. Element 8G is a conceptual diagram illustrating rubber blade of 4 way cleaner unit. Element 8H is a conceptual diagram illustrating backup motor forward motor servo for tilt controlled by server. Element 8I is a conceptual diagram illustrating connection of tubing for cleaner fluid to sprayer blade. Element 8J is a conceptual diagram illustrating the servo to apply tension on the cleaner blades.

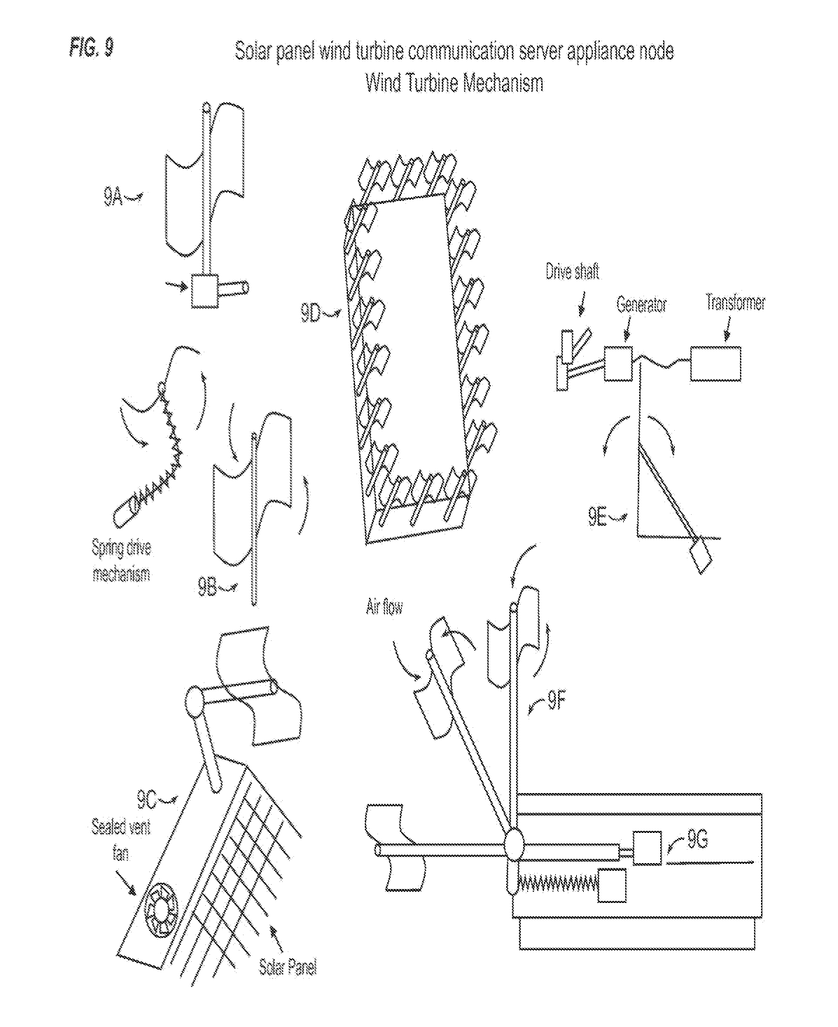

FIG. 9 is an enlarged illustration view of the terrestrial based solar panel wind turbine communication server appliance node wind turbine mechanism. Element 9A is an enlarged illustration view of the plastic or aluminum all ways of wind direction wind blade. Element 9B is an enlarged illustration view of the air flow from any direction. Element 9C is an enlarged illustration view of the folding wind turbine apparatus with sealed vent fan mechanism. Element 90 is an enlarged illustration view of the mini wind turbines fully extended for maximum electricity generation. Element 9E is an enlarged illustration view of the servo tilting mechanism controlled by main server for adjusting the shadow off the solar panel area. Element 9F is an enlarged illustration view of the tilt and store mechanism of the mini wind turbine apparatus. Element 9G is an enlarged illustration view of the coil and magnetic electric generator connected to the mini wind turbine mechanism.

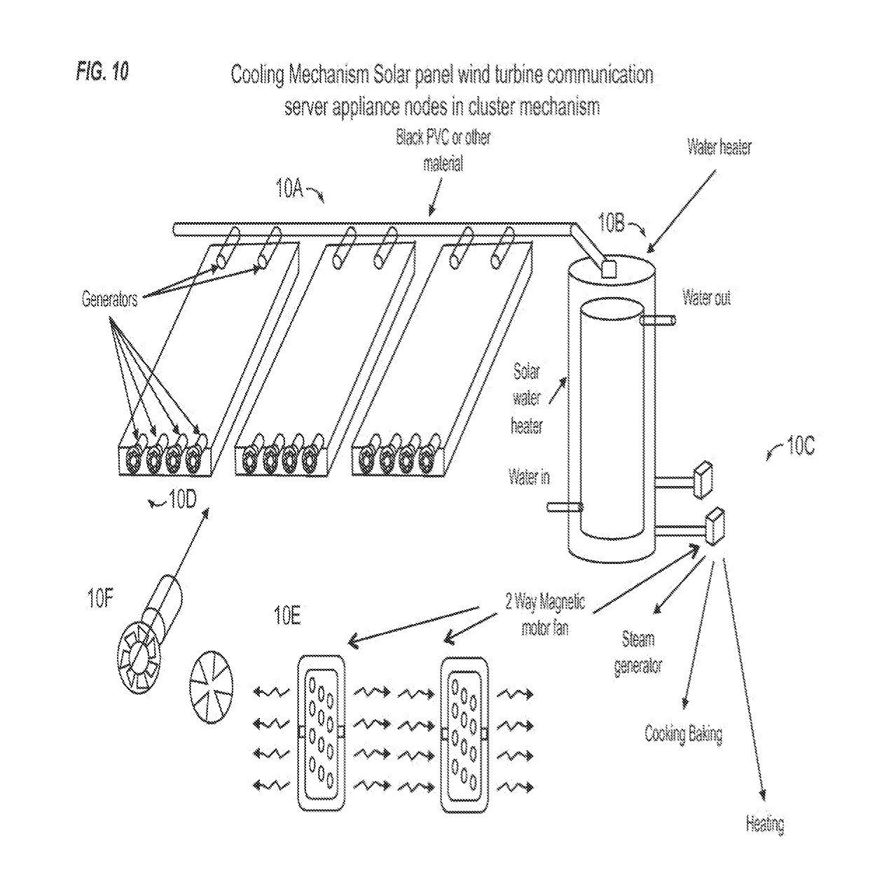

FIG. 10 is an illustration view of the cooling mechanism for terrestrial based solar panel wind turbine communication server appliance nodes in cluster. Element 10A is an illustration view of the black bottom and clear top thermal generation pipe system apparatus. Element 10B is an illustration view of the solar water heater mechanism. Element 10C is an illustration view of the no voltage or low voltage with electric override mechanism vent fan system as it flows to steam generator, cooking or baking unit, or heating areas. Element 10D is an illustration view of the magnetic fan generators or electric override motors connected to the moisture sealed vent covers. Element 10E is an illustration view of the 2 way magnetic fan with electric override apparatus for heating generation, and back flow for heating solar panel wind turbine communication server appliance nodes in winter for defrosting. Element 10F is an illustration view of the moisture seal mechanism for input of air into the server node mechanism.

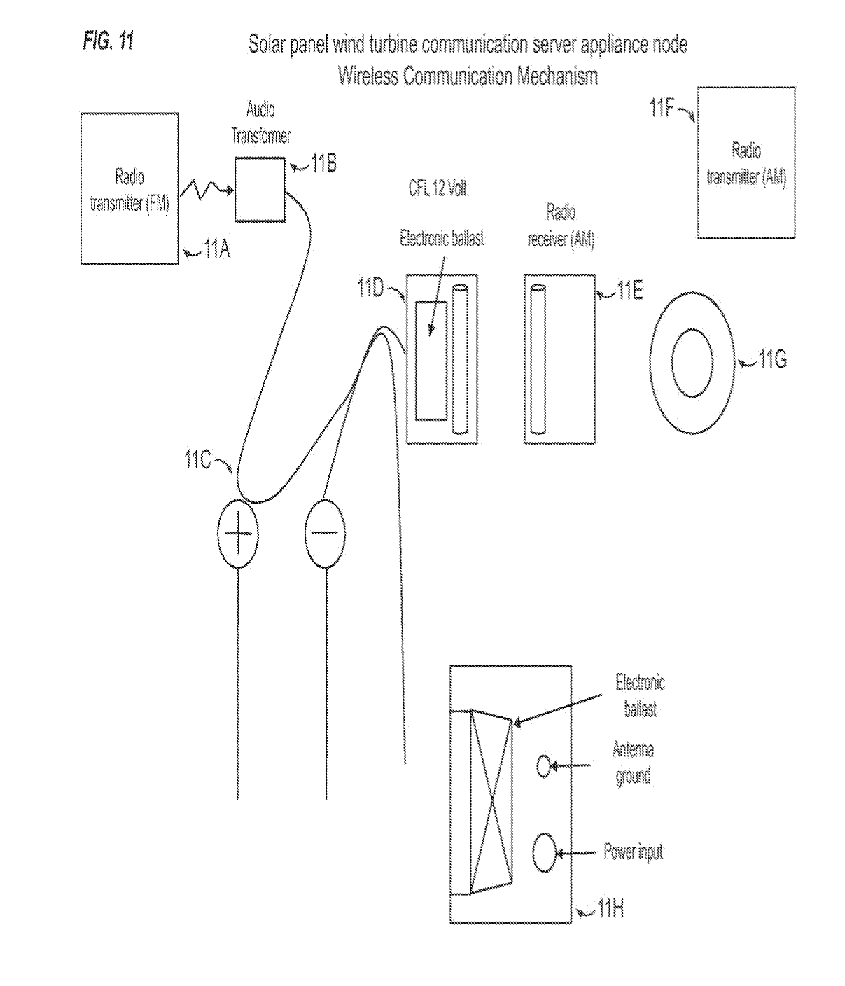

FIG. 11 is an alternative embodiment of the apparatus for wireless energy transfer from the terrestrial based solar panel wind turbine communication server appliance node with wireless communication mechanism. Element 11A is an alternative embodiment of the apparatus for wireless energy transfer that shows the radio transmitter or VOIP unit for 10 cell communications. Element 11B is an alternative embodiment of the apparatus for wireless energy transfer that shows the audio transformer mechanism. Element 11C is an alternative embodiment of the apparatus for wireless energy transfer that shows plus and minus positive and negative DC electricity into the apparatus. Element 11D is an alternative embodiment of the apparatus for wireless energy transfer that shows 12 volt electronic ballast and transmitter coil. Element 11E is an alternative embodiment of the apparatus for wireless energy transfer that shows receiver coil. Element 11F is an alternative embodiment of the apparatus for wireless energy transfer that shows radio receiver, mobile device, wireless device, smart device, artificial intelligence device, and/or robot. Element 11G is an alternative embodiment of the apparatus for wireless energy transfer that shows transformer, battery, 100 volt led bulb, or anything that needs electricity. 11H Illustrates the electronic ballast as related to the antenna ground and power input for wireless energy transfer for the transmission to the receiver unit.

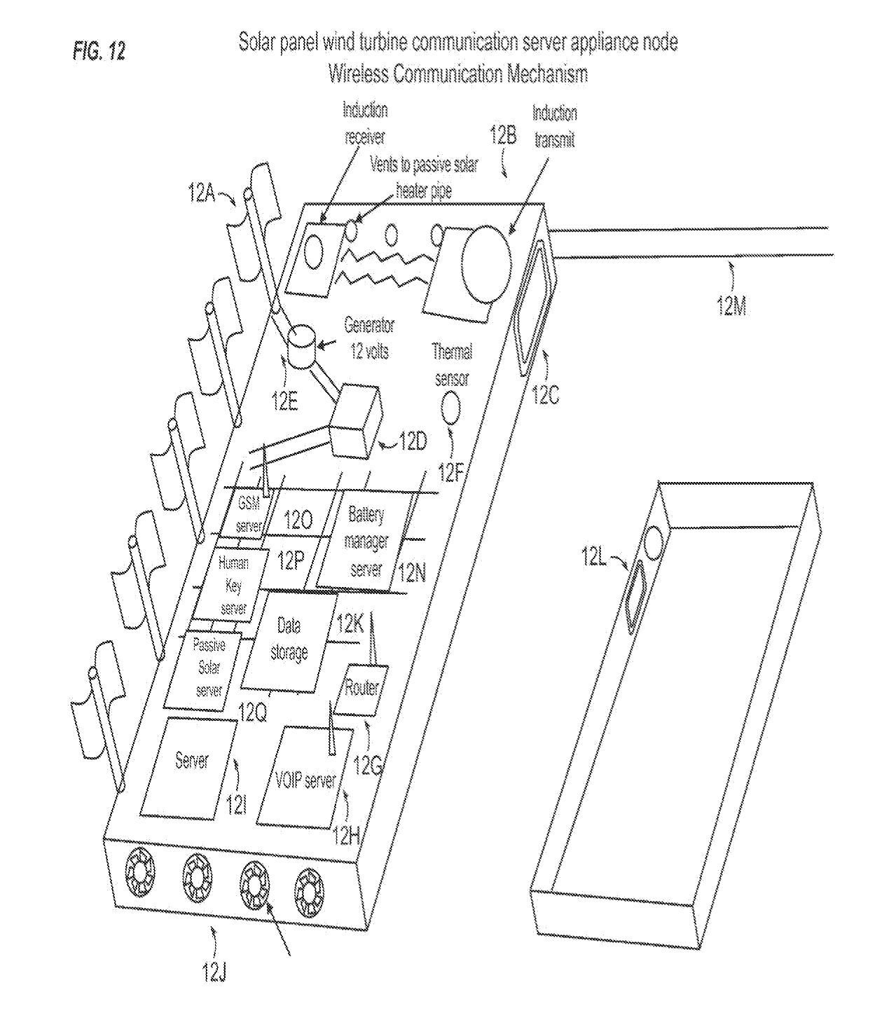

FIG. 12 is a cross sectional diagram, of the wireless VOIP terrestrial based solar panel wind turbine communication server appliance node apparatus according to an embodiment of the present invention. Element 12A is a cross sectional diagram, that shows wind power generator for nighttime electricity generation apparatus according to an embodiment of the present invention. Element 12B is a cross sectional diagram, that shows vents from solar panel wind turbine communication server appliance node to passive solar heater pipe apparatus according to an embodiment of the present invention. Element 12C is a cross sectional diagram, that shows transmitter energy coil apparatus according to an embodiment of the present invention. Element 120 is a cross sectional diagram that shows transformer and internal thermal sensor area apparatus according to an embodiment of the present invention. Element 12E is a cross sectional diagram, that shows magnetic generator connected to mini wind turbines apparatus according to an embodiment of the present invention. Element 12F is a cross sectional diagram, that shows the solar panel surface above the solar panel wind turbine communication server appliance node components apparatus according to an embodiment of the present invention. Element 12G is a cross sectional diagram that shows the solar panel wind turbine communication server appliance node communication router apparatus according to an embodiment of the present invention. Element 12H is a cross sectional diagram, that shows the solar panel wind turbine communication server appliance node communication VOIP server apparatus according to an embodiment of the present invention. Element 12I is a cross sectional diagram, that shows the solar panel wind turbine communication server appliance node low voltage main server apparatus according to an embodiment of the present invention. Element 12J is a cross sectional diagram, that shows the solar panel wind turbine communication server appliance node low voltage input fans apparatus according to an embodiment of the present invention. Element 12K is a cross sectional diagram, that shows the solar panel wind turbine communication server appliance node data storage apparatus according to an embodiment of the present invention. Element 12L is a cross sectional diagram that shows the solar panel wind turbine communication server appliance node receiver coil apparatus according to an embodiment of the present invention. Element 12M is a cross sectional diagram, that shows the solar panel wind turbine communication server appliance node passive solar heater smart vent tube apparatus according to an embodiment of the present invention having a Element 12N is a cross sectional diagram, that shows the solar panel wind turbine communication server appliance node battery manager server mechanism. Element 12O is a cross sectional diagram, that shows the solar panel wind turbine communication server appliance node GSM server mechanism board. Element 12P is a cross sectional diagram, that shows the solar panel wind turbine communication server appliance node protect anything Prot2 human key server mechanism. Element 12Q is a cross sectional diagram, that shows the solar panel wind turbine communication server appliance node passive solar server management mechanism.

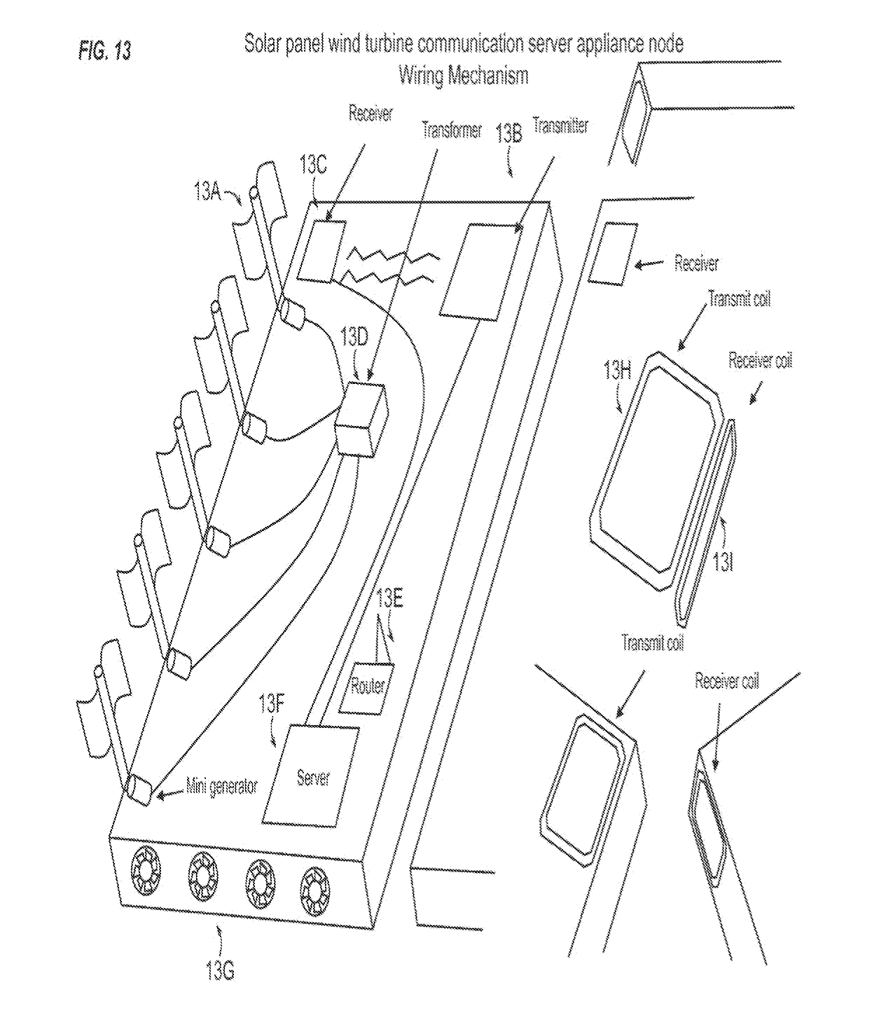

FIG. 13 is an enlarged view of the solar server wiring mechanism. Element 13A is an enlarged view of the solar server wiring mechanism connected to the mini wind turbines mechanism. Element 13B is an enlarged view of the solar server wiring mechanism connected transmitter coil mechanism. Element 13C is an enlarged view of the solar server wiring mechanism connected receiver coil mechanism. Element 13D is an enlarged view of the solar server wiring mechanism connected to the mini wind turbines mechanism and connected to transformer. Element 13E is an enlarged view of the solar server wiring mechanism connected router mechanism. Element 13F is an enlarged view of the solar server wiring mechanism connected main server mechanism. Element 13G is an enlarged view of the solar server wiring mechanism connected sealed vent fans mechanism. Element 13H is an enlarged view of the solar server wiring mechanism connected square transmitter coil mechanism. Element 13I is an enlarged view of the solar server wiring mechanism connected square receiver coil mechanism.

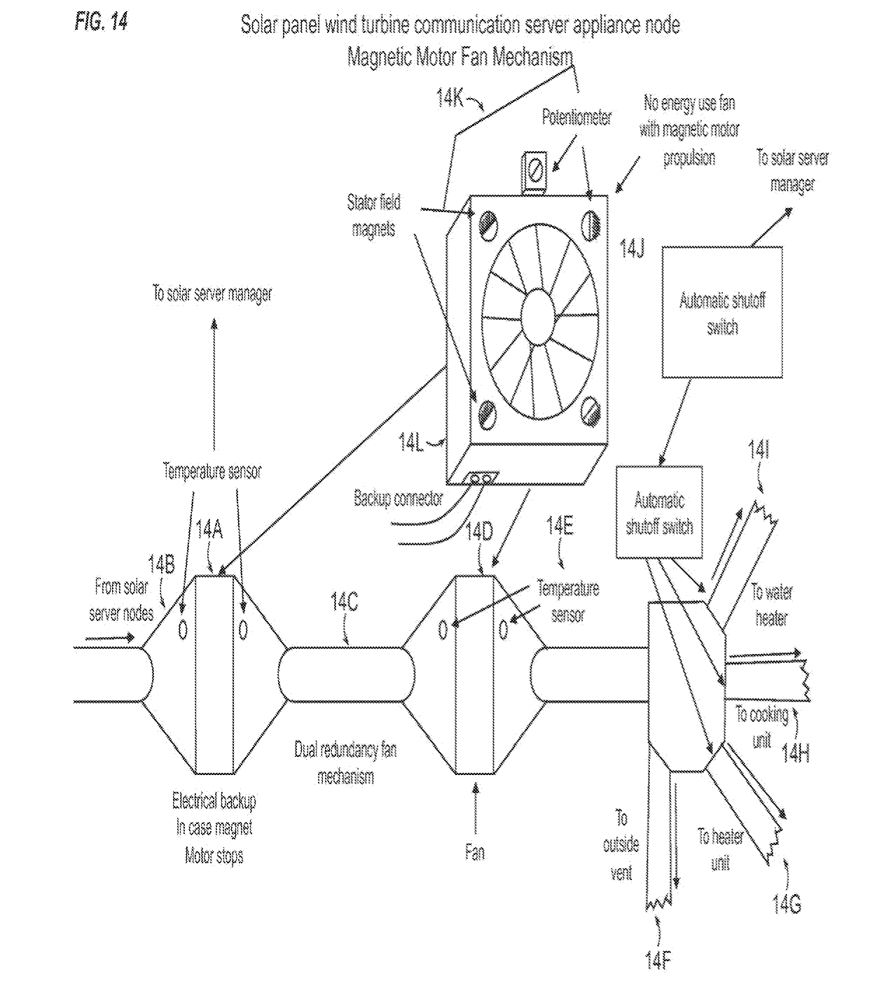

FIG. 14 is an illustration of the terrestrial based solar panel wind turbine communication server appliance node magnetic motor apparatus. Element 14A is an illustration of the apparatus which shows the magnetic motor with electrical backup mechanism. Element 14B is an illustration of the apparatus which shows the thermal sensors mechanism. Element 14C is an illustration of the apparatus which shows the passive solar pipe mechanism. Element 140 is an illustration of the apparatus which shows the second redundant magnetic motor with electrical backup mechanism. Element 14E is an illustration of the apparatus which shows the thermal sensor mechanism. Element 14F is an illustration of the apparatus which shows the control cutoff valve pipe to outside vent mechanism controlled by solar panel wind turbine communication server appliance node sensing unit manager mechanism. Element 14G is an illustration of the apparatus which shows the control cutoff valve pipe to heater unit mechanism controlled by solar panel wind turbine communication server appliance node sensing unit manager mechanism. Element 14H is an illustration of the apparatus which shows the control cutoff valve pipe to cooking unit mechanism controlled by solar panel wind turbine communication server appliance node sensing unit manager mechanism. Element 14I is an illustration of the apparatus which shows the control cutoff valve pipe to water heater mechanism controlled by solar panel wind turbine communication server appliance node sensing unit manager mechanism. Element 14J is an illustration of the apparatus which shows the magnetic motor mechanism. Element 14K is an illustration of the apparatus which shows the stator and potentiometer components of the magnetic motor mechanism. Element 14L is an illustration of the apparatus which shows the backup electrical connector components of the magnetic motor mechanism.

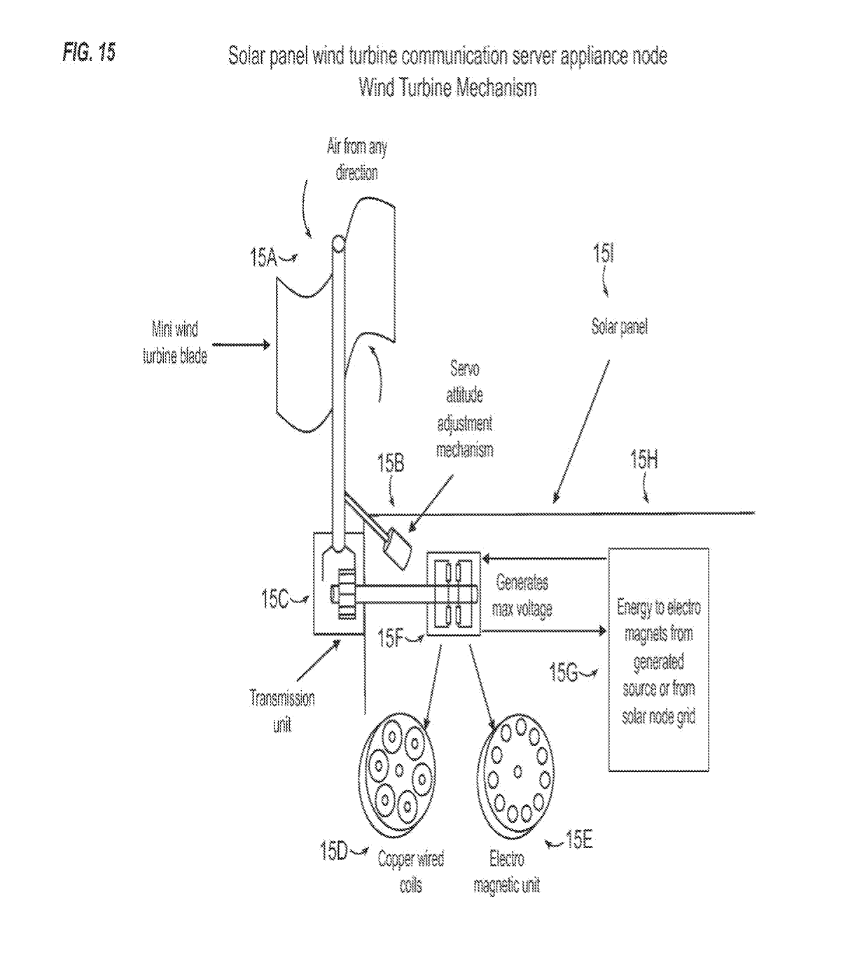

FIG. 15 is an illustration diagram representative of terrestrial based solar panel wind turbine communication server appliance node wind turbine mechanism. Element 15A is an illustration diagram representative of mini wind turbine blade for universal wind from any direction mechanism. Element 158 is an illustration diagram representative of mini wind turbine blade servo attitude adjustment mechanism. Element 15C is an illustration diagram representative of mini wind turbine blade gear transmission mechanism. Element 15D is an illustration diagram representative of mini wind turbine blade copper generator wired coils mechanism. Element 15E is an illustration diagram representative of mini wind turbine blade magnetic coils mechanism. Element 15F is an illustration diagram representative of mini wind turbine blade copper generator mechanism. Element 15G is an illustration diagram representative of 100 volts generated. Element 15H is an illustration diagram representative of mini wind turbine blade copper generator energy to electro magnets from generated source or from solar node grid mechanism. Element 151 is an illustration diagram representative of surface of the solar panel wind turbine communication server appliance node panel mechanism.

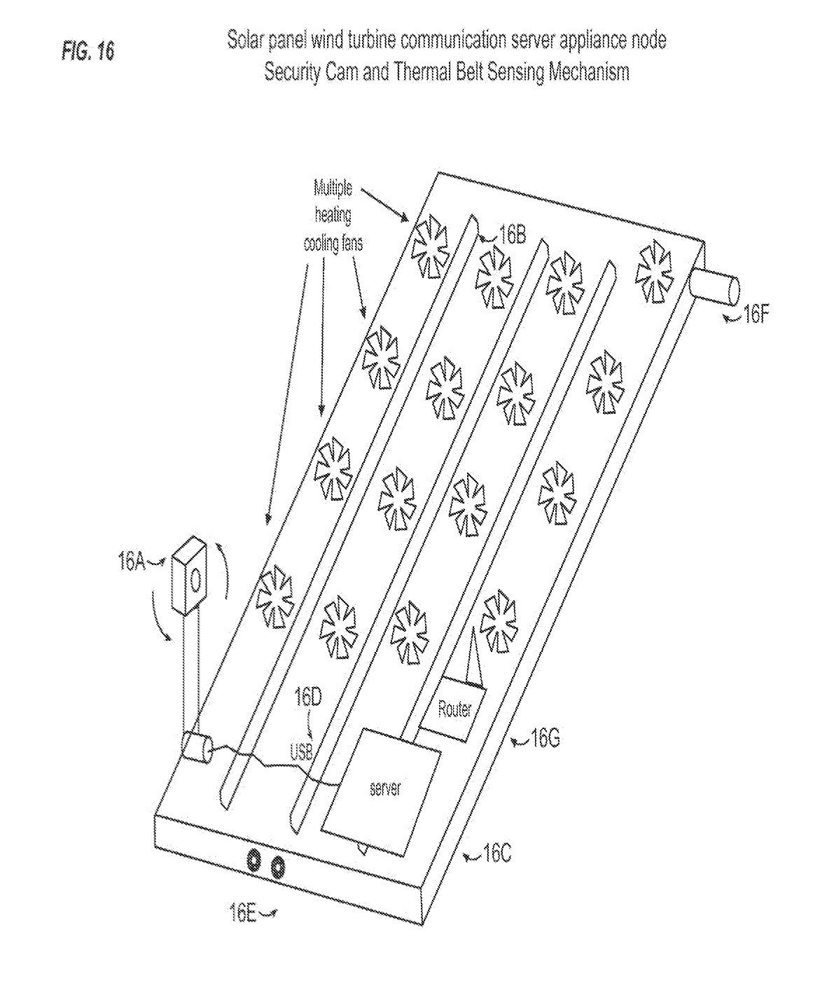

FIG. 16 is a conceptual illustration representative of the terrestrial based solar panel wind turbine communication server appliance node security cam & thermal belt sensing mechanism. Element 16A is a conceptual illustration representative of maintenance security cam for viewing the whole cluster of nodes. Element 16B is a conceptual illustration representative of thermal, gaseous, light sensor, belt mechanism. Element 16C is a conceptual illustration representative of main server mechanism. Element 160 is a conceptual illustration representative of USB connector from cam to main server mechanism. Element 16E is a conceptual illustration representative of moisture resistant input vents. Element 16F is a conceptual illustration representative of cooling vent into the passive solar panel wind turbine communication server appliance node pipe system mechanism. Element 16G is a conceptual illustration representative of communication router mechanism.

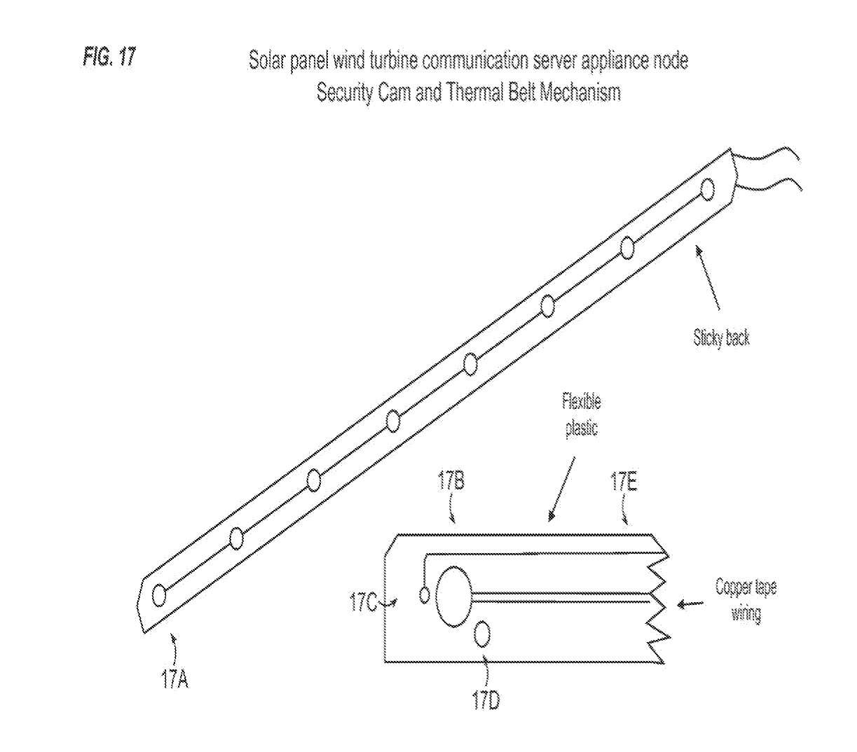

FIG. 17 is a conceptual diagram illustrating a terrestrial based solar panel wind turbine communication server appliance node thermal belt sensing mechanism in an embodiment of the present invention. Element 17 A is a conceptual diagram illustrating a thermal belt sensor mechanism that gives temperature at the specific point in the mechanism in an embodiment of the present invention. Element 17B is a conceptual diagram illustrating a thermal belt sensor mechanism that gives gaseous reading at the specific point in the mechanism in an embodiment of the present invention. Element 17C is a conceptual diagram illustrating a thermal belt sensor mechanism that gives temperature at the specific point in the mechanism in an embodiment of the present invention. Element 17D is a conceptual diagram illustrating a thermal belt sensor mechanism that gives light sensor at the specific point in the mechanism in an embodiment of the present invention. Element 17E is a conceptual diagram illustrating a thermal belt sensor mechanism that gives flexible plastic with copper embedded wiring at the specific point in the mechanism in an embodiment of the present invention.

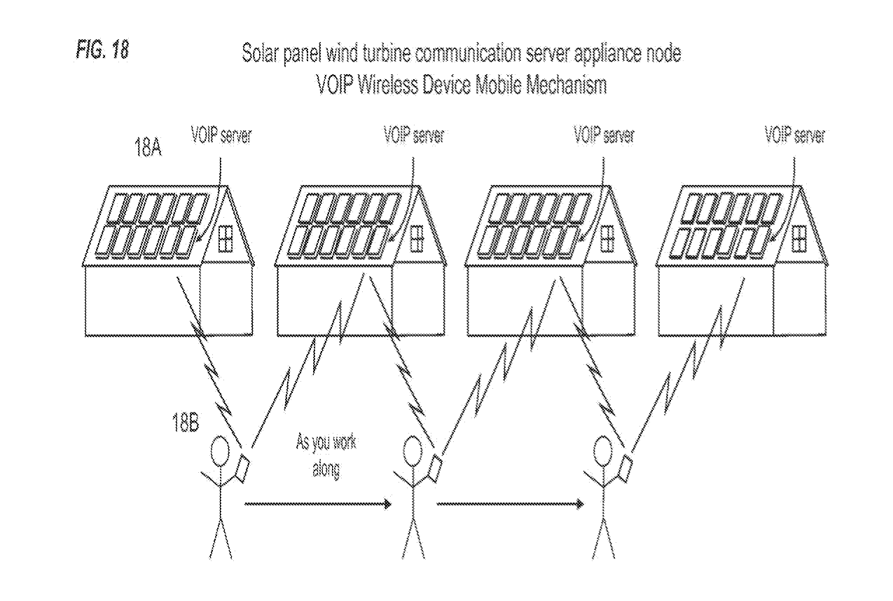

FIG. 18 is a conceptual diagram illustrating a method and mechanism for terrestrial based solar panel wind turbine communication server appliance node VOIP wireless device mobile cell phone mechanism in an embodiment of the present invention. Element 18A is a conceptual diagram illustrating a method and mechanism for many clustered solar panel wind turbine communication server appliance nodes making a network of solar panel wind turbine communication server appliance node clusters each with a voice over internet protocol server for continuous wireless communication in a mobile device in embodiment of the present invention. Element 18B is a conceptual diagram illustrating a method and mechanism for walking along near the solar panel wind turbine communication server appliance node clusters and connecting to the network continuously in embodiment of the present invention.

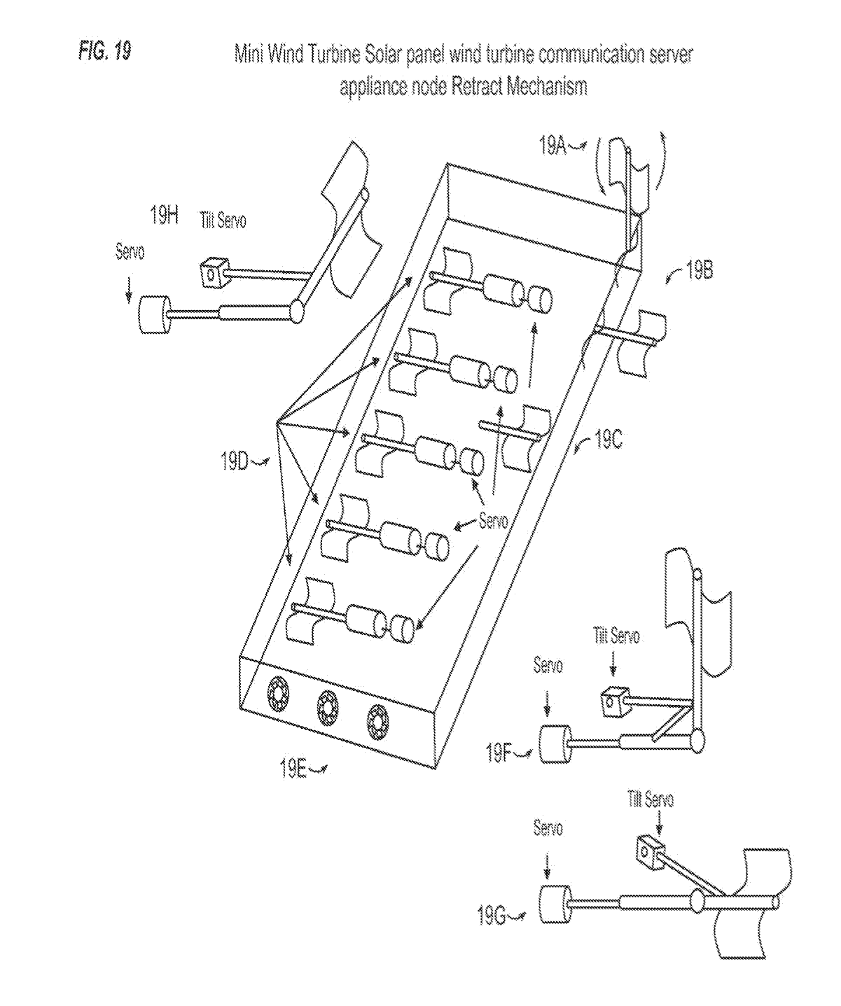

FIG. 19 is a conceptual diagram illustrating a method and mechanism for mini wind turbine terrestrial based solar panel wind turbine communication server appliance node retractable mechanism according to another embodiment of the present invention. Element 19A is a conceptual diagram illustrating a method and mechanism for mini wind turbine in full use in another embodiment of the present invention. Element 19B is a conceptual diagram illustrating a method and mechanism for mini wind turbine in retracted mode due to rough weather in another embodiment of the present invention Element 19C is a conceptual diagram illustrating a method and mechanism for mini wind turbine in retracted into the solar panel wind turbine communication server appliance node unit for inclement weather protection in another embodiment of the present invention Element 19D is a conceptual diagram illustrating a method and mechanism for mini wind turbines fully retracted in another embodiment of the present invention Element 19E is a conceptual diagram illustrating a method and mechanism for mini wind turbines retracted with vents in another embodiment of the present invention Element 19F is a conceptual diagram illustrating a method and mechanism for mini wind turbine in use with tilt servo and generator retractor mechanism in another embodiment of the present invention Element 19G is a conceptual diagram illustrating a method and mechanism for mini wind turbine in retractor mode with servo retraction mode use in another embodiment of the present invention Element 19H is a conceptual diagram illustrating a method and mechanism for mini wind turbine in full use showing tilt mini wind turbines to decrease shadows on solar panels during different times of day in another embodiment of the present invention

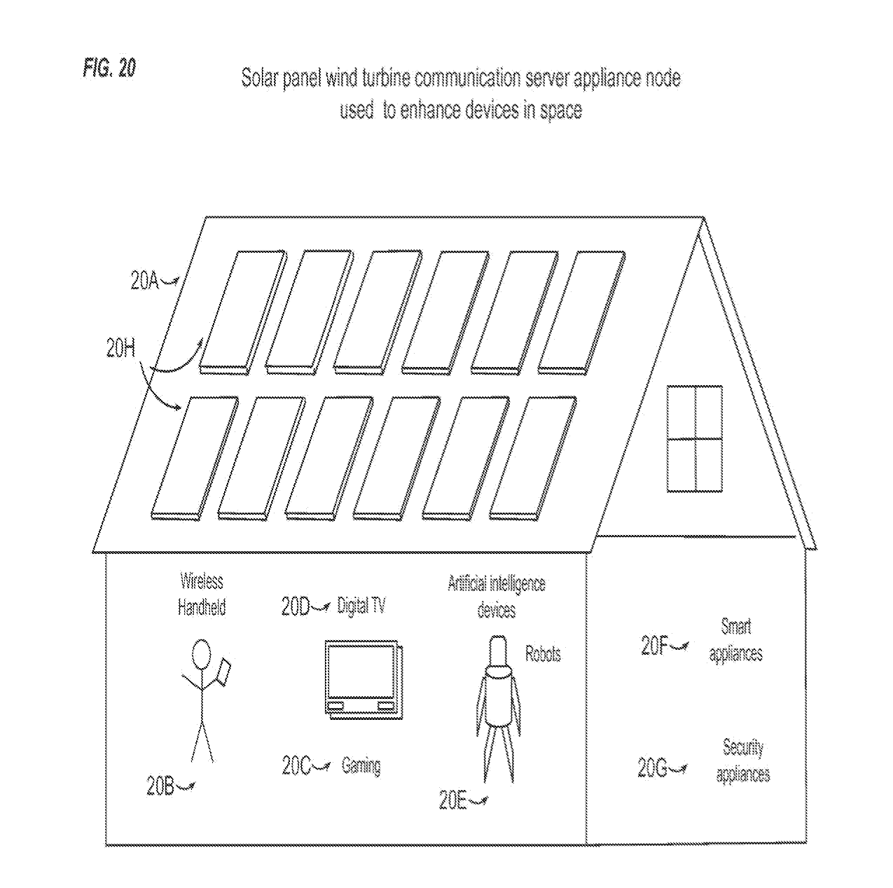

FIG. 20 is a conceptual diagram illustrating a method and mechanism for terrestrial based solar panel wind turbine communication server appliance node wireless or wired remote transfer of information to smart devices, robots, artificial intelligent agents mechanism in another embodiment of the present invention. Element 20A is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information use in another embodiment of the present invention. Element 20B is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information with wireless handheld devices in another embodiment of the present invention. Element 20C is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information gaming in another embodiment of the present invention. Element 20D is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information digital TV 3D or high definition TV in another embodiment of the present invention. Element 20E is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information artificial intelligence, robots in another embodiment of the present invention. Element 20F is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information smart appliances in another embodiment of the present invention. Element 20G is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information security appliances in another embodiment of the present invention. Element 20H is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information utilizing the supercomputer aspects of the solar panel wind turbine communication server appliance node cluster for research remotely in another embodiment of the present invention.

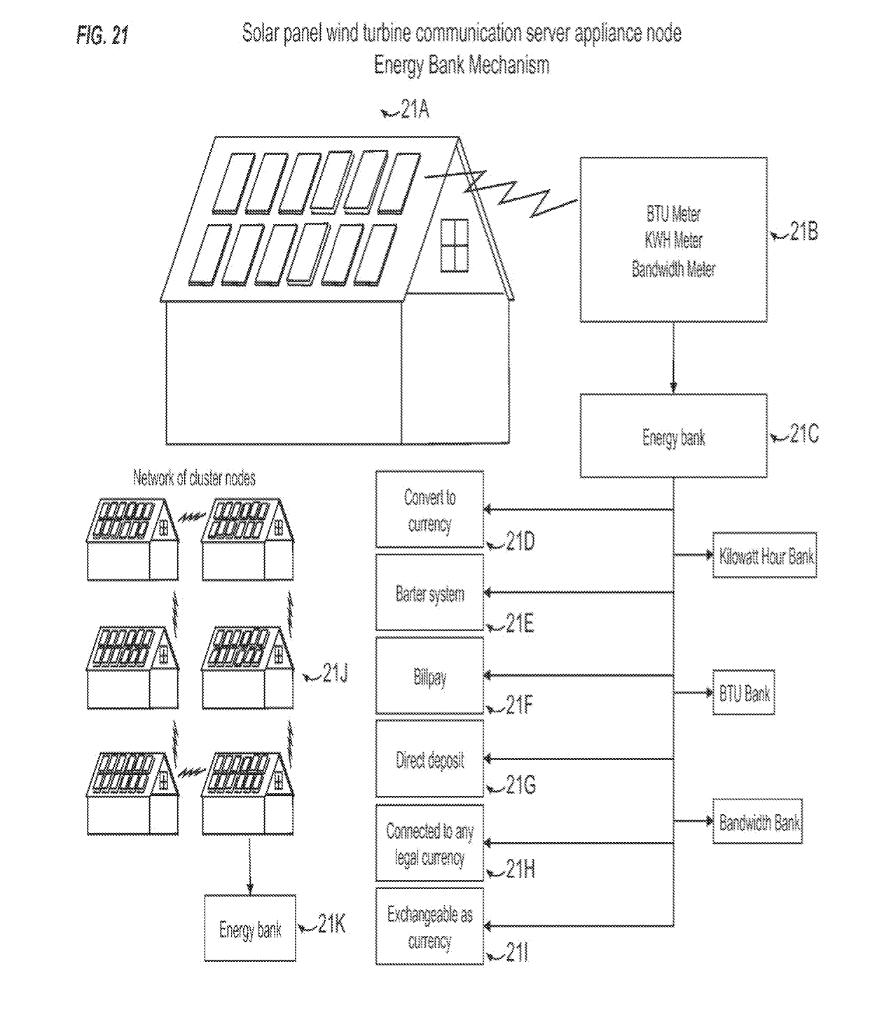

FIG. 21 is an illustration flow chart diagram of apparatus according to one embodiment of the present invention having a terrestrial based solar panel wind turbine communication server appliance node network energy bank method and mechanism. Element 21A is an illustration flow chart diagram of apparatus according to one embodiment of the present invention having a cluster of solar panel wind turbine communication server appliance nodes mechanism connected to energy bank mechanism. Element 21B is an illustration flow chart diagram of apparatus according to one embodiment of the present invention having a virtual metering BTU Meter, KILOWATT HOURS Meter, and Bandwidth Meter mechanism connected to energy bank mechanism. Element 21C is an illustration flow chart diagram of apparatus according to one embodiment of the present invention having an energy bank method and mechanism. Element 21D is an illustration flow chart diagram of apparatus according to one embodiment of the present invention having ability to convert to currencies connected to energy bank mechanism. Element 21E is an illustration flow chart diagram of apparatus according to one embodiment of the present invention having ability to have a barter system connected to energy bank mechanism. Element 21F is an illustration flow chart diagram of apparatus according to one embodiment of the present invention having a bill pay system connected to energy bank mechanism. Element 21G is an illustration flow chart diagram of apparatus according to one embodiment of the present invention having a direct deposit system connected to energy bank mechanism. Element 21H is an illustration flow chart diagram of apparatus according to one embodiment of the present invention having ability to connect and attach to any legal currency connected to energy bank mechanism. Element 211 is an illustration flow chart diagram of apparatus according to one embodiment of the present invention having ability to be exchangeable as currency connected to energy bank mechanism. Element 21J is an illustration flow chart diagram of apparatus according to one embodiment of the present invention having a network of solar server cluster nodes connected to energy bank mechanism. Element 21K is an illustration flow chart diagram of apparatus according to one embodiment of the present invention having an energy bank mechanism.

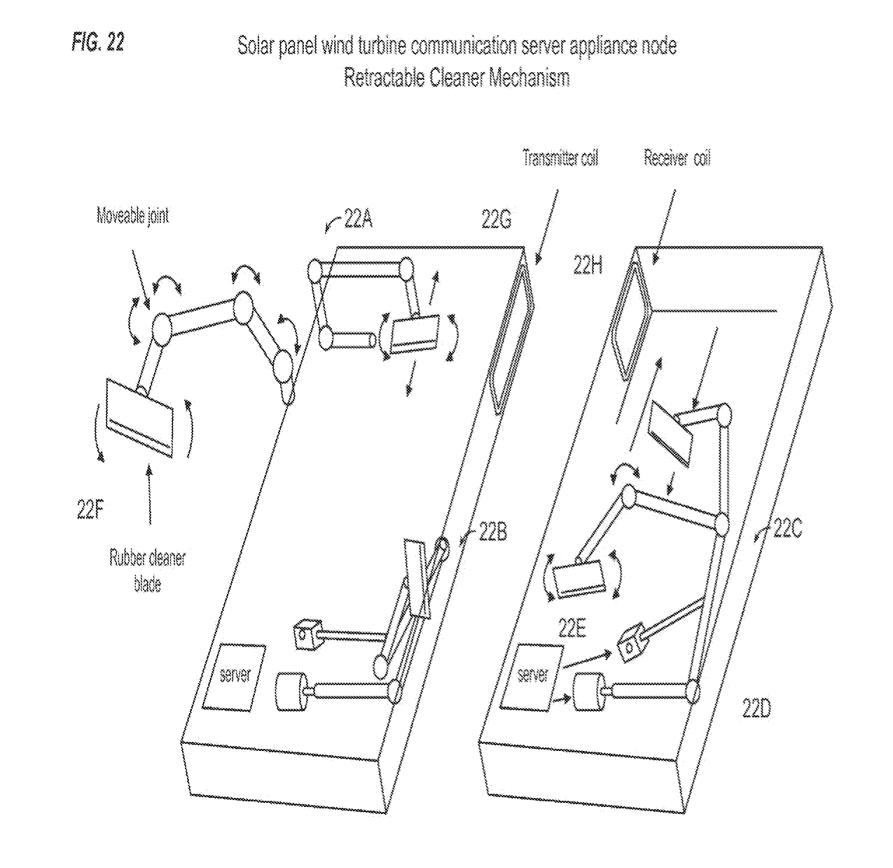

FIG. 22 is a conceptual diagram illustrating the terrestrial based solar panel wind turbine communication server appliance node retractable robotic cleaner mechanism. Element 22A is a conceptual diagram illustrating flexible robotic cleaner arm that can rotate or go any direction to clear debris or heavy snow from surface of solar panel wind turbine communication server appliance node panel mechanism. Element 22B is a conceptual diagram illustrating flexible robotic cleaner arm that can rotate or go any direction to clear debris or heavy snow from surface of solar panel wind turbine communication server appliance node panel in retracted mode mechanism. Element 22C is a conceptual diagram illustrating flexible robotic cleaner arm that can rotate or go any direction to clear debris or heavy snow from surface of solar panel wind turbine communication server appliance node panel in use mechanism. Element 22D is a conceptual diagram illustrating flexible robotic cleaner arm that can rotate or go any direction to clear debris or heavy snow from surface of solar panel wind turbine communication server appliance node panel connected to main server for control locally or wireless, remotely mechanism. Element 22E is a conceptual diagram illustrating control for robotic arm through main server unit mechanism. Element 22F is a conceptual diagram illustrating flexible robotic cleaner arm that can rotate or go any direction to clear debris or heavy snow from surface of solar panel wind turbine communication server appliance node panel with rubber cleaner scraper blade and all ways movable joint mechanism. Element 22G is a conceptual diagram illustrating energy transmitter coil mechanism. Element 22H is a conceptual diagram illustrating energy receiver coil mechanism.

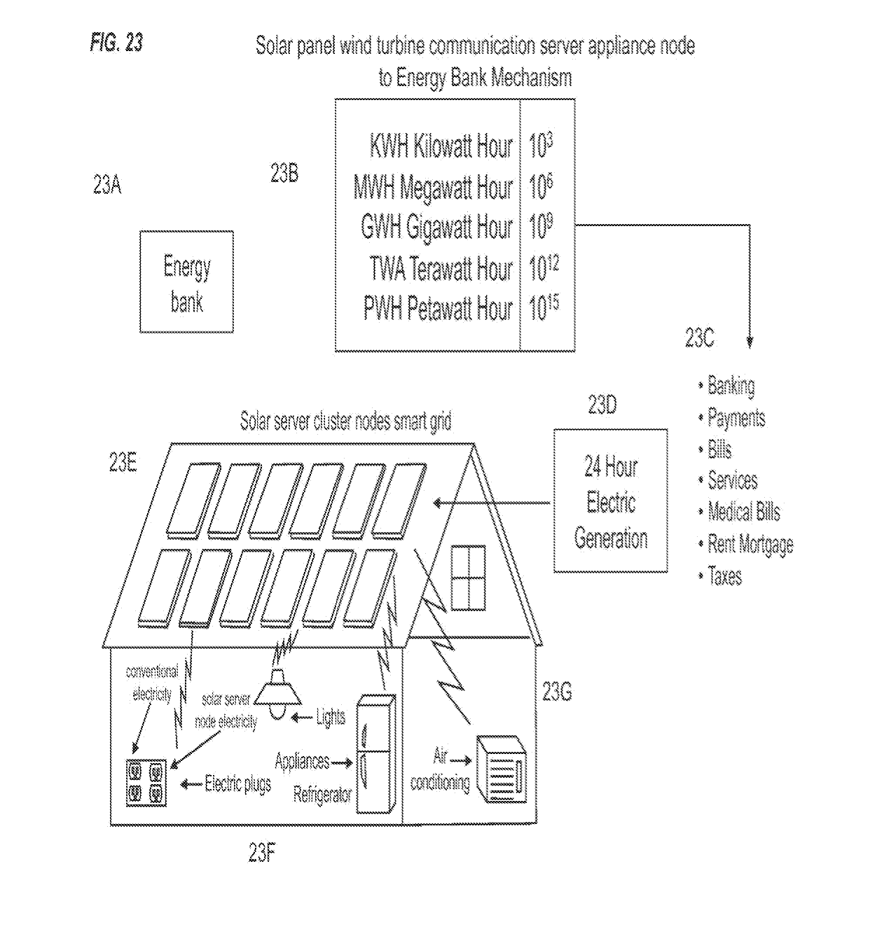

FIG. 23 is an flow chart and illustration view of terrestrial based solar panel wind turbine communication server appliance node cluster to energy bank method and mechanism. Element 23A is an flow chart and illustration view of energy bank method and mechanism. Element 23B is an flow chart and illustration view of measurement banks in KILOWATT HOURS, MWH, GWH, TWH, PWH meters mechanism. Element 23C is an flow chart and illustration view of how one can do banking, payments, bills, services, medical bills, rent mortgages, taxes with the virtual bank mechanism. Element 23D is an flow chart and illustration view of solar panel wind turbine communication server appliance nodes connected to the energy bank for automatic 24 hour electric generation and deposits mechanism. Element 23E is an flow chart and illustration view of solar server cluster nodes smart grid mechanism. Element 23F is an flow chart and illustration view of connected wirelessly to electric plugs, lights, appliances, air conditioning method and shows how additional funds are generated from selling energy back to the convention grid power companies with mechanism. Element 23G is an flow chart and illustration view of where additional funds generated from selling energy back to the conventional grid and power companies 24 hour 7 days energy generation with surplus going into energy bank for use as currency and with additional funds generated from selling energy back to the convention grid power companies by users of solar server network or conversion for use outside network with mechanism.

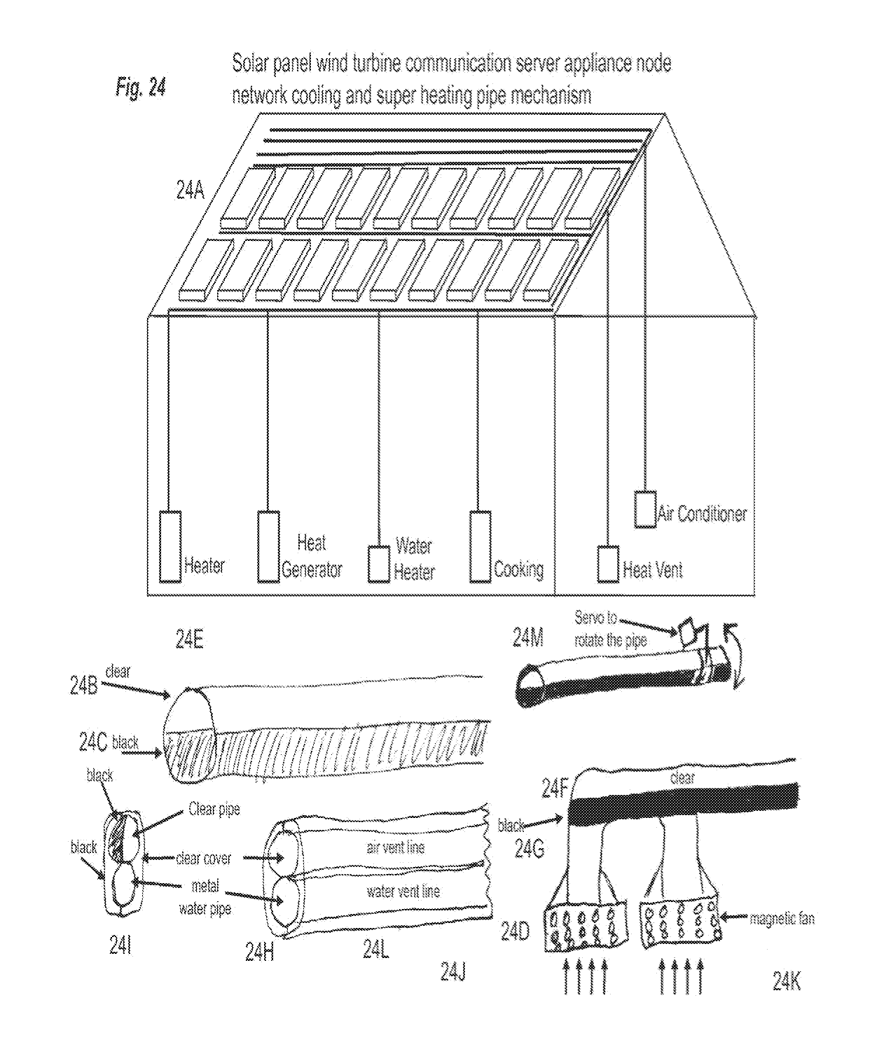

FIG. 24 is a cross sectional diagram, of the terrestrial based solar panel wind turbine communication server appliance node network cooling and super heating passive solar pipe apparatus according to an embodiment of the present invention. Element 24A is a cross sectional diagram, shows the black base with clear top tubing for passive solar heat generation running through multiple connections to the solar panel wind turbine communication server appliance node cluster grid apparatus according to an embodiment of the present invention, the pipe lines to the different needs of the space below connected to the heater, heat generator, water heater, cooking, heat vent and air conditioner. Element 24B is a cross sectional diagram, of the clear part of the tubing mechanism apparatus according to an embodiment of the present invention. Element 24C is a cross sectional diagram, of the black heat absorption area of the tubing mechanism apparatus according to an embodiment of the present invention. Element 240 is a cross sectional diagram, of the magnetic fans apparatus according to an embodiment of the present invention. Element 24E is a cross sectional diagram, of the mechanism showing all piping rotation systems and magnetic vent fans are controlled by the main server with thermal senso strip apparatus according to an embodiment of the present invention and how all piping rotation systems and magnetic vent fans are controlled by the main server with thermal sensor strip. Element 24F is a cross sectional diagram, of the clear and black passive solar tubing apparatus according to an embodiment of the present invention having a Element 24G is a cross sectional diagram, of the clear black separation apparatus according to an embodiment of the present invention. Element 24H is a cross sectional diagram, of the snap on clear container for the winter air vent piping and water line piping apparatus and pipes can be rotated inside clear cover dual pipe apparatus for additional regulation according to an embodiment of the present invention. Element 24I is a cross sectional diagram, of the side view of piping apparatus where pipes can be rotated inside the winter heating black bottom container and clear winter cover, with air pipe and water pipe and Pipes can be rotated inside clear cover dual pipe apparatus for additional regulation according to an embodiment of the present invention. Element 24J is a cross sectional diagram, of where in the winter the mechanism can take heat to each room, and to the water heater for hot water and cooking apparatus according to an embodiment of the present invention. Element 24K is a cross sectional diagram, of where in the summer can divert main heat to electric heat generator for electric air conditioning cooling and the rest to the water heater apparatus and in winter can take heat to each room, and to water heater for hot water and cooking, and in summer can divert main heat to electric heat generator and the rest to water heater according to an embodiment of the present invention. Element 24L is a cross sectional diagram, of where snap on cover for additional winter heat, snap off cover for lower heat needs in summer apparatus according to an embodiment of the present invention having a Element 24M is a cross sectional diagram, of where piping can actually turn from dark to clear for increased heat and turn from clear to dark for decreased heat with a servo that is controlled by the main server, for optimum heat dispersal at different points of the solar panel wind turbine communication server appliance node mechanism apparatus according to an embodiment of the present invention having a mechanism that opens clear for more heat turns to dark side for less heat generated works with water line or air line.

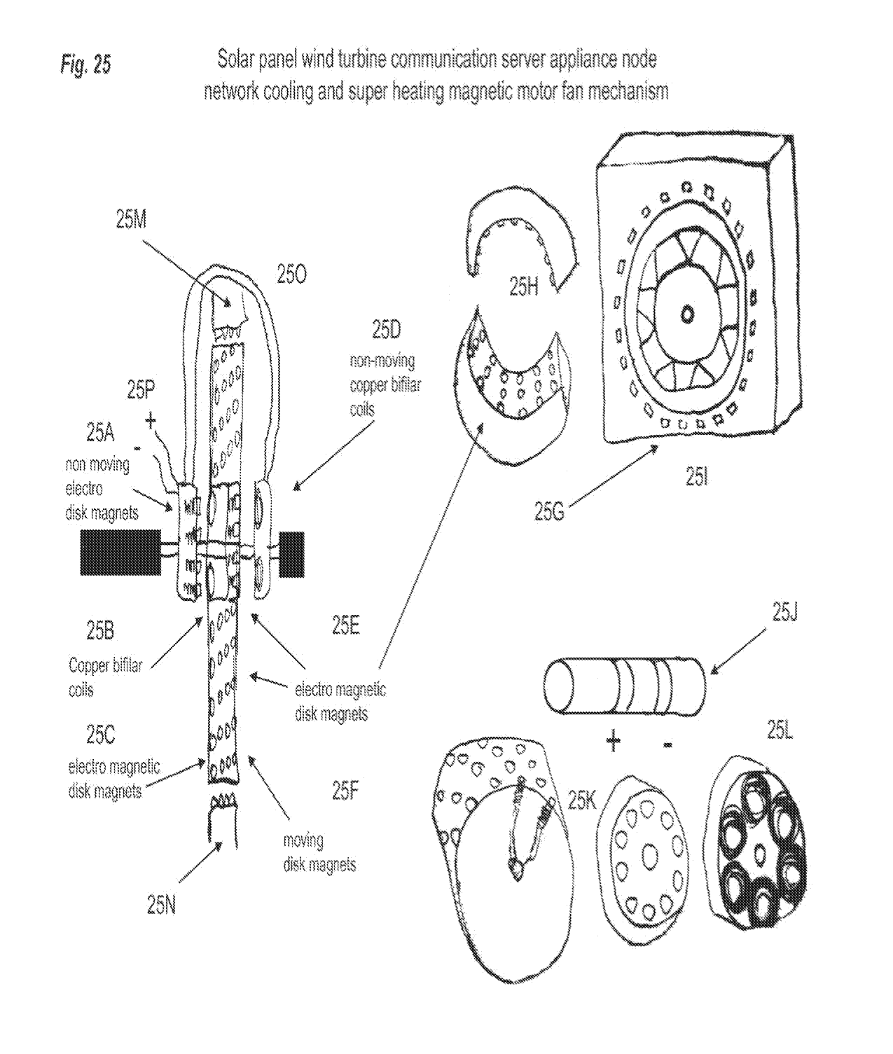

FIG. 25 describes the solar panel wind turbine communication server appliance node network cooling and super heating magnetic motor fan mechanism with electro magnetic motor ventilation fan that runs by itself with no power but has an override mechanism connected to main server to be able to run with electrical assistance in case of failure and additional speed. Element25A is a cross sectional diagram, of the non moving electromagnetic mechanism. Element25B is a cross sectional diagram, of the copper bifilar coils apparatus. Element25C is a cross sectional diagram, of the electromagnetic disk magnets mechanism. Element25D is a cross sectional diagram, of the non moving copper bifilar coils apparatus. Element25E is a cross sectional diagram, of the electromagnetic disk magnets mechanism. Element25F is a cross sectional diagram, of the moving disk magnets mechanism. Element25G is a cross sectional diagram, of the fan housing for magnetic energy motor ventilator apparatus. Element25H is a cross sectional diagram, of the electromagnetic disk magnets clamp for motor starter mechanism. Element25I is a cross sectional diagram, of the front fan housing mechanism. Element25J is a cross sectional diagram, of the plus and minus contact for center rotor electromagnetic disk magnets electricity provided for the turning center disk magnets power supply. Element25K is a cross sectional diagram, of the center rotor electromagnetic disk wired, and electro magnetic disk magnets connected to center rotor mechanism. Element25L is a cross sectional diagram, of the electromagnetic disk generator mechanism and the copper bifilar coils generator mechanism Element25M is a cross sectional diagram, of the non-moving disk magnets clamp starter mechanism. Element25N is a cross sectional diagram, of the non-moving disk magnets clamp starter mechanism. Element250 is a cross sectional diagram, of the wiring plus and minus harness connected from generator bifilar coils to electromagnetic generator mechanism for power to the electro magnets. Element25P is a cross sectional diagram, of the extra electricity generated is sent to the grid, energy bank, or used by user.

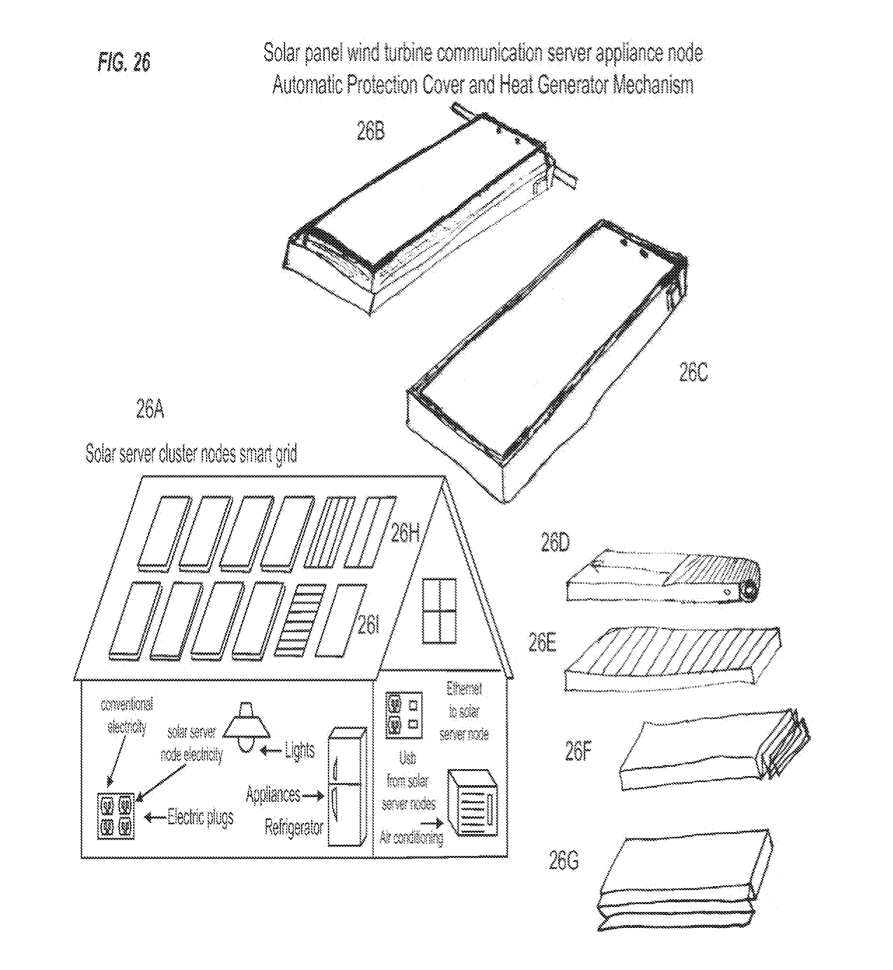

FIG. 26 is a conceptual diagram illustrating a method and mechanism for the solar panel wind turbine communication server appliance node automatic protection cover and heat generator mechanism with different styles of solar server node or solar panel protection covers that automatically can cover the solar panel surface for heat generation or protection from storms trees hail stones and have an infrared solar panel top for generating electricity at night and during cloud cover. Element26A is a conceptual diagram illustrating a method and mechanism that describes the solar server cluster nodes smart grid with examples of the covering system on a house mechanism. Element26B is a conceptual diagram illustrating a method and mechanism that shows the inflated flexible side mechanism with the clear thick Plexiglas or glass top cover for creating heat or automatically protecting the surface of the solar panel or solar panel node mechanism. Element26C is a conceptual diagram illustrating a method and mechanism that shows the retracted mode with the glass or Plexiglas flat on the surface, and no air space between the clear materials. Element26D is a conceptual diagram illustrating a method and mechanism that shows the roll top style cover mechanism. Element26E is a conceptual diagram illustrating a method and mechanism that shows the fully covered retractable style mechanism. Element26F is a conceptual diagram illustrating a method and mechanism that shows the cover retracted at top of solar panel or solar panel node mechanism. Element26G is a conceptual diagram illustrating a method and mechanism that shows the cover retracted at side of solar panel or solar panel node mechanism. Element26H is a conceptual diagram illustrating a method and mechanism that shows the embedded solar panel or node with a 2 panel cover sliding cover or 4 panel retracting cover mechanism. Element26I is a conceptual diagram illustrating a method and mechanism that shows the embedded solar panel retracting mechanism or permanently mounted inside roof and clear glass, or Plexiglas protective covering, built into a skylight as a standalone solar panel wind turbine communication server appliance node with a skylight mechanism.

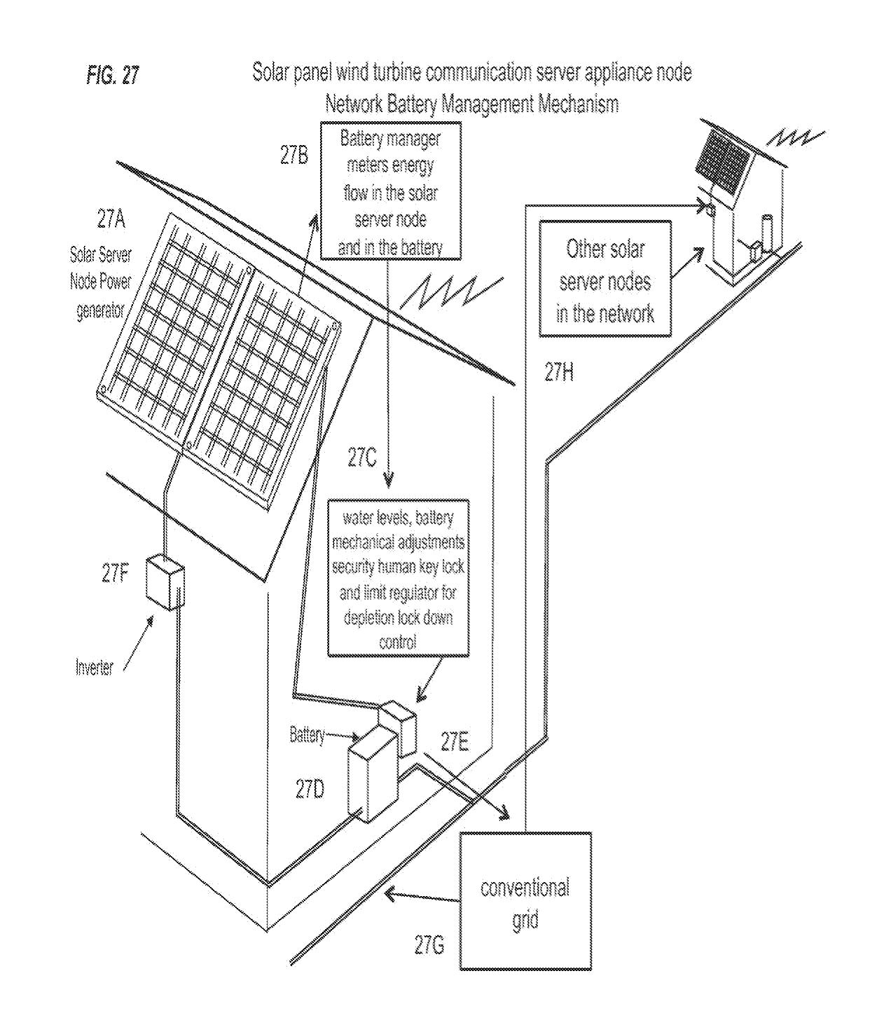

FIG. 27 is a conceptual diagram illustrating a method and mechanism that shows solar panel wind turbine communication server appliance node network battery management mechanism and Cluster of solar server nodes of each network solar server array, so if the power and communication grid goes down the system can communicate and get power from the other members of the solar server network grid, where batteries are managed by the network for balancing use in the network, and excessive power is sent to grid or KWH energy bank. Element27 A is a conceptual diagram illustrating a method and mechanism that shows the solar panel wind turbine communication server appliance node power generator mechanism. Element27B is a conceptual diagram illustrating a method and mechanism that shows how Battery manager meters energy flow in the solar panel wind turbine communication server appliance node and in the battery mechanism. Element27C is a conceptual diagram illustrating a method and mechanism that shows apparatus that controls water levels, battery mechanical adjustments security human key lock and limit regulator for depletion lock down control mechanism. Element27D is a conceptual diagram illustrating a method and mechanism that shows the battery storage mechanism Element27E is a conceptual diagram illustrating a method and mechanism that shows the flow of electricity to the grid. Element27F is a conceptual diagram illustrating a method and mechanism that shows the solar panel wind turbine communication server appliance node cluster inverter mechanism. Element27G is a conceptual diagram illustrating a method and mechanism that shows the conventional grid. Element27H is a conceptual diagram illustrating a method and mechanism that shows other solar panel wind turbine communication server appliance node clusters in the network that get shared electricity.

Fig. is a conceptual diagram illustrating a method and mechanism that shows Solar panel wind turbine communication server appliance node audio to human ear and mobile receiver targeted zones mechanism. Element 28A is a conceptual diagram illustrating a method and mechanism that shows the solar panel wind turbine communication server appliance node lasers for audio transmission to spatial point. Element 28B is a conceptual diagram illustrating a method and mechanism that shows audio transmission to spatial point zone near left ear. Element 28C is a conceptual diagram illustrating a method and mechanism that shows audio transmission spatial point zone near right ear. Element 28D is a conceptual diagram illustrating a method and mechanism that shows audio transmission to spatial point zone near 3D left speaker of mobile phone. Element28E is a conceptual diagram illustrating a method and mechanism that shows audio transmission to spatial point zone near 3D right speaker of mobile phone.

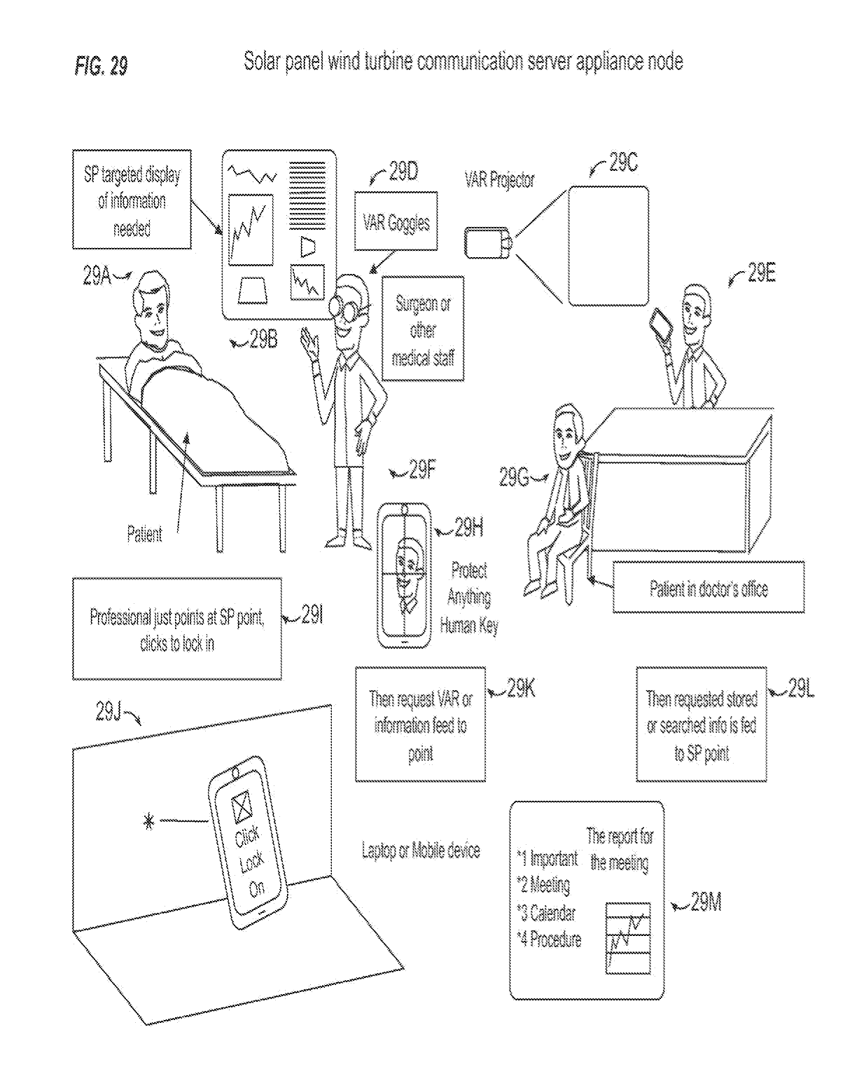

FIG. 29 is a conceptual diagram illustrating a method and mechanism that shows Solar panel wind turbine communication server appliance node network professional lawyer, accountant, institutional, medical SP point with Virtual Augmented reality display related to patients' records, surgical procedures, medical references. Element 29A describes How Data is processed through Protect Anything Human Key and professional mechanism for lawyer, accountant, institutional, medical, SP target point with virtual augmented reality display related to patient records, surgical procedures, and medical references and shows patient laying on the bed. Element 29B describes How Data is processed through Protect Anything Human Key and professional mechanism for lawyer, accountant, institutional, medical, SP target point with virtual augmented reality display related to patient records, surgical procedures, and medical references and shows SP targeted display of information needed with charts and text, images, video and surgeon or other medical staff with VAR goggles. Element 29C describes How Data is processed through Protect Anything Human Key and professional mechanism for lawyer, accountant, institutional, medical, SP target point with virtual augmented reality display related to patient records, surgical procedures, and medical references and shows a VAR. Projector for a meeting. Element 29D describes How Data is processed through Protect Anything Human Key and professional mechanism for lawyer, accountant, institutional, medical, SP target point with virtual augmented reality display related to patient records, surgical procedures, and medical references and shows in goggles you can have data broadcast to it for usability. Element 29E describes How Data is processed through Protect Anything Human Key and professional mechanism for lawyer, accountant, institutional, medical, SP target point with virtual augmented reality display related to patient records, surgical procedures, and medical references and shows can interact with virtual augmented reality project or mobile image on screen in mobile device. Element 29F describes How Data is processed through Protect Anything Human Key and professional mechanism for lawyer, accountant, institutional, medical, SP target point with virtual augmented reality display related to patient records, surgical procedures, and medical references and shows patient and doctors office looking at virtual augmented reality protection of charts. Element 29G describes How Data is processed through Protect Anything Human Key and professional mechanism for lawyer, accountant, institutional, medical, SP target point

with virtual augmented reality display related to patient records, surgical procedures, and medical references and shows where you have to use the Protect Anything Human Key identification system to be able to read your charts medical financial or whatever that way your charts and information goes with you wherever you go. Element 29H describes How Data is processed through Protect Anything Human Key and professional mechanism for lawyer, accountant, institutional, medical, SP target point with virtual augmented reality display related to patient records, surgical procedures, and medical references and shows the professional chess points at any SP target point clicks to lock in target for display. Element 29I describes How Data is processed through Protect Anything Human Key and professional mechanism for lawyer, accountant, institutional, medical, SP target point with virtual augmented reality display related to patient records, surgical procedures, and medical references and shows. Element 29J describes How Data is processed through Protect Anything Human Key and professional mechanism for lawyer, accountant, institutional, medical, SP target point with virtual augmented reality display related to patient records, surgical procedures, and medical references and shows mobile device with can microphone and crosshairs you target then click lock on. Element 29K describes How Data is processed through Protect Anything Human Key and professional mechanism for lawyer, accountant, institutional, medical, SP target point with virtual augmented reality display related to patient records, surgical procedures, and medical references and shows then request virtual augmented reality media for information feed or broadcast to that point. Element 29L describes How Data is processed through Protect Anything Human Key and professional mechanism for lawyer, accountant, institutional, medical, SP target point with virtual augmented reality display related to patient records, surgical procedures, and medical references and shows than the requested stored or searched information is fed or broadcast to SP target point. Element 29M describes How Data is processed through Protect Anything Human Key and professional mechanism for lawyer, accountant, institutional, medical, SP target point with virtual augmented reality display related to patient records, surgical procedures, and medical references and shows the media being viewed.

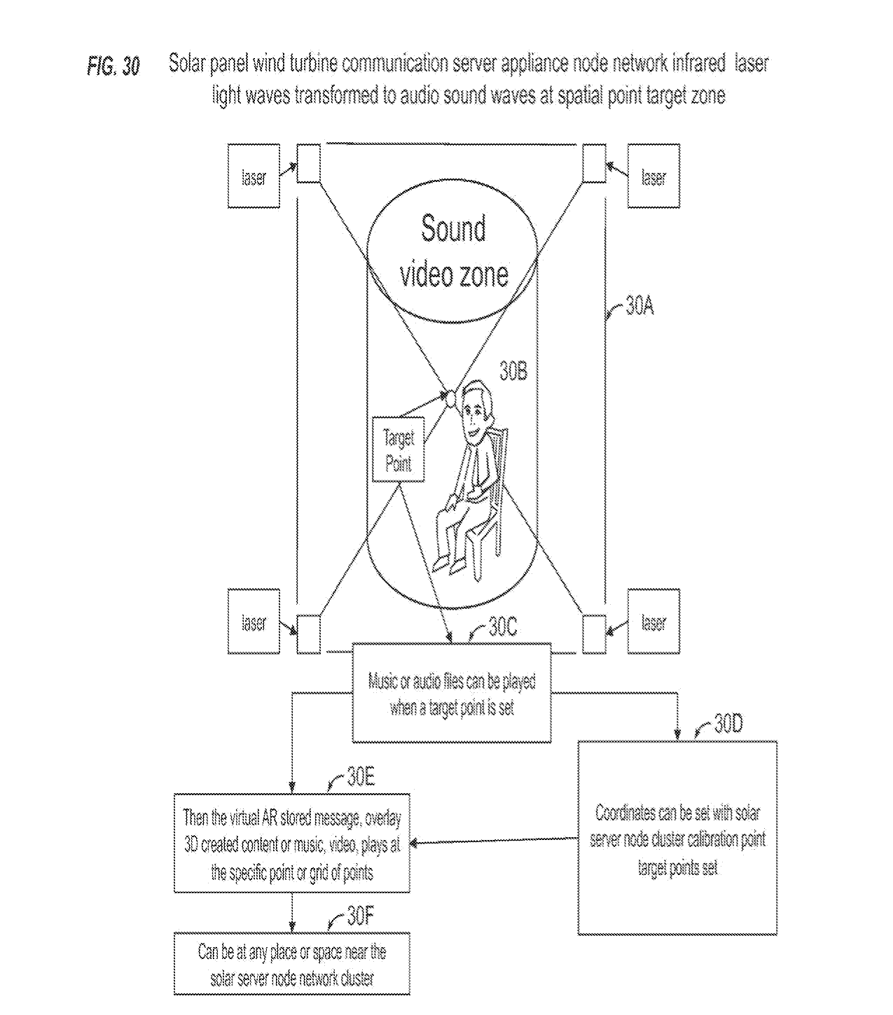

FIG. 30 is a conceptual diagram illustrating a method and mechanism that shows Solar panel wind turbine communication server appliance node network infrared laser light waves transformed to audio sound waves at spatial point target zone Element30A is a conceptual diagram illustrating a method and mechanism that shows Infrared laser connected to the solar panel wind turbine communication server appliance node network. Element30B is a conceptual diagram illustrating a method and mechanism that shows sound video zone point target with person hearing and viewing video. Element30C is a conceptual diagram illustrating a method and mechanism that shows where music or audio files can be played when a target point is set. Element30D is a conceptual diagram illustrating a method and mechanism that shows where coordinates can be set with solar panel wind turbine communication server appliance node cluster calibration point target points set. Element30E is a conceptual diagram illustrating a method and mechanism that shows where Then the virtual AR stored message, overlay 3D created content or music, video, plays at the specific point or grid of points. Element30F is a conceptual diagram illustrating a method and mechanism that shows where can be at any place or space near the solar panel wind turbine communication server appliance node network cluster.

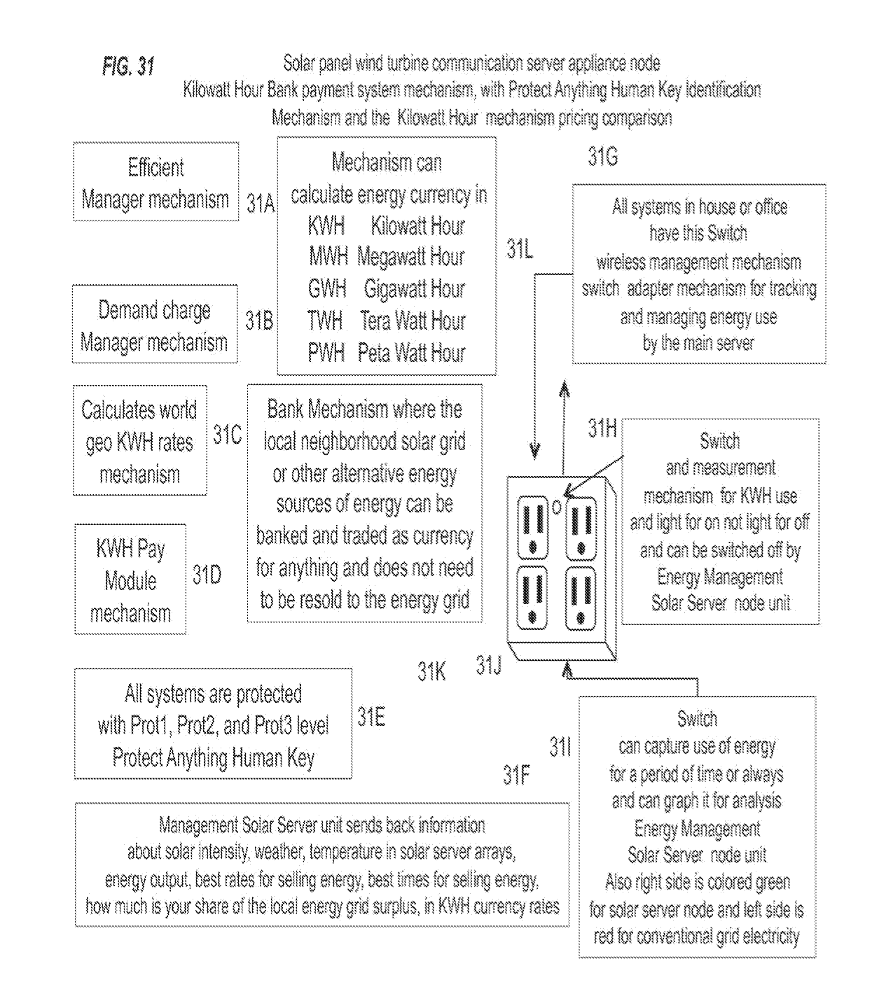

FIG. 31 describes Kilowatt Hour Bank payment system mechanism, with Protect Anything Human Key Identification Mechanism and the Kilowatt Hour mechanism pricing comparison. Element 31A describes Kilowatt Hour Bank payment system mechanism, with Protect Anything Human Key Identification Mechanism and the Solar panel wind turbine communication server appliance node network Kilowatt Hour pricing comparison to product registry mechanism and shows the Solar panel wind turbine communication server appliance node network energy Efficient Manager mechanism. Element 31B describes Kilowatt Hour Bank payment system mechanism, with Protect Anything Human Key Identification Mechanism and the Solar panel wind turbine communication server appliance node network Kilowatt Hour pricing comparison to product registry mechanism and shows the Demand charge Manager Mechanism. Element 31C describes Kilowatt Hour Bank payment system mechanism, with Protect Anything Human Key Identification Mechanism and the Solar panel wind turbine communication server appliance node network Kilowatt Hour pricing comparison to product registry mechanism and shows the Calculates world geo KILOWATT HOURS rates mechanism. Element 31D describes Kilowatt Hour Bank payment system mechanism, with Protect Anything Human Key Identification Mechanism and the Solar panel wind turbine communication server appliance node network Kilowatt Hour pricing comparison to product registry mechanism and shows the KILOWATT HOURS Pay Module mechanism. Element 31E describes Kilowatt Hour Bank payment system mechanism, with Protect Anything Human Key Identification Mechanism and the Solar panel wind turbine communication server appliance node network Kilowatt Hour pricing comparison to product registry mechanism and shows that all energy systems are protected with Prot1, Prot2, and Prot3 level Protect Anything Human Key. Element 31F describes Kilowatt Hour Bank payment system mechanism, with Protect Anything Human Key Identification Mechanism and the Solar panel wind turbine communication server appliance node network Kilowatt Hour pricing comparison to product registry mechanism and shows the Solar panel wind turbine communication server appliance node network energy Management Solar Server unit sends back information about solar intensity, weather, temperature in solar server arrays, energy output, best rates for selling energy, best times for selling energy, how much is your share of the local energy grid surplus, in KILOWATT HOURS currency rates. Element 31G describes Kilowatt Hour Bank payment system mechanism, with Protect Anything Human Key Identification Mechanism and the Solar panel wind turbine communication server appliance node network Kilowatt Hour pricing comparison to product registry mechanism and shows that All systems in house or office have the Solar panel wind turbine communication server appliance node network wireless management switch adapter mechanism for tracking and managing energy use by the main Solar panel wind turbine communication server appliance node network energy server. Element 31H describes Kilowatt Hour Bank payment system mechanism, with Protect Anything Human Key Identification Mechanism and the Solar panel wind turbine communication server appliance node network Kilowatt Hour pricing comparison to product registry mechanism and shows the Solar panel wind turbine communication server appliance node network energy Switch adapter and measurement mechanism for KILOWATT HOURS use and light for on not light for off and can be switched off by Solar panel wind turbine communication server appliance node network Energy Management Solar Server unit. Element 31I describes Kilowatt Hour Bank payment system mechanism, with Protect Anything Human Key Identification Mechanism and the Solar panel wind turbine communication server appliance node network Kilowatt Hour pricing comparison to product registry mechanism and shows the Solar panel wind turbine communication server appliance node network energy Switch adapter can capture use of energy for a period of time or always and can graph it for analysis Solar panel wind turbine communication server appliance node network Energy Management Solar Server unit. Element 31J describes Kilowatt Hour Bank payment system mechanism, with Protect Anything Human Key Identification Mechanism and the Solar panel wind turbine communication server appliance node network Kilowatt Hour pricing comparison to product registry mechanism and shows the Solar panel wind turbine communication server appliance node network energy Switch adapter. Element 31K describes Kilowatt Hour Bank payment system mechanism, with Protect Anything Human Key Identification Mechanism and the Solar panel wind turbine communication server appliance node network Kilowatt Hour pricing comparison to product registry mechanism and shows the Solar panel wind turbine communication server appliance node network energy Bank Mechanism where the local neighborhood solar grid energy or other alternative energy sources of energy can be banked and traded as currency for anything and does not need to be resold to the energy grid. Element 31L describes Kilowatt Hour Bank payment system mechanism, with Protect Anything Human Key Identification Mechanism and the Solar panel wind turbine communication server appliance node network Kilowatt Hour pricing comparison to product registry mechanism and shows where energy in the Solar panel wind turbine communication server appliance node network energy system can calculate energy currency in KILOWATT HOURS Kilowatt Hour, or larger amounts for industry like MWH Megawatt Hour, GWH Gig watt Hour, TWH Tera Watt Hour, PWH Peta Watt Hour.

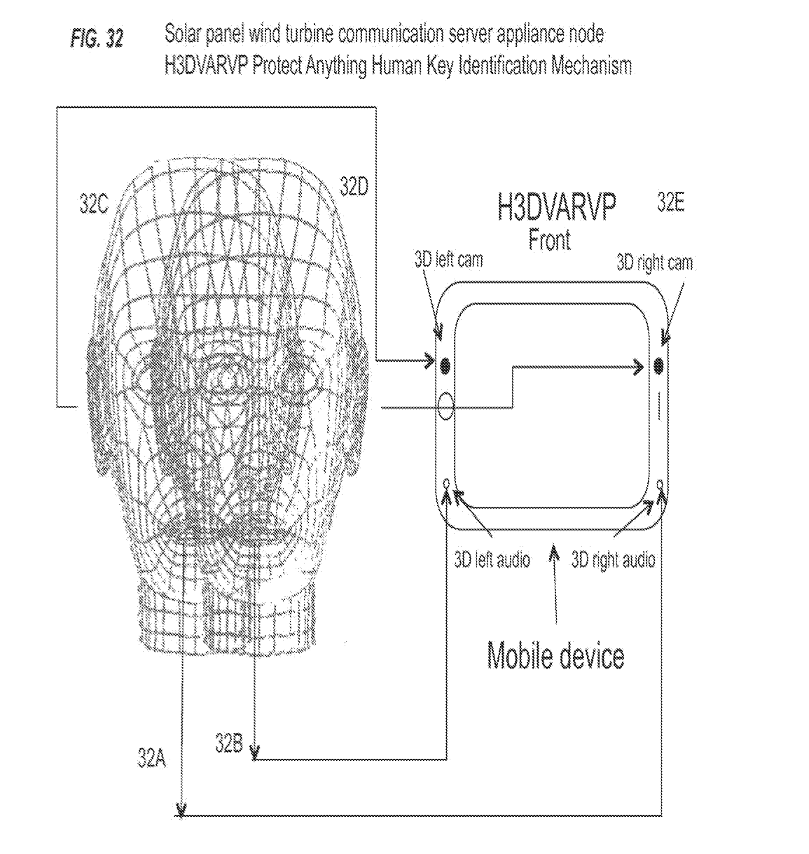

FIG. 32 describes H3DVARVP Protect Anything Human Key Identification Mechanism. Element 32A describes left audio input into H3DVARVP. Element 32B describes right audio input into H3DVARVP. Element 32C describes left video input into H3DVARVP. Element 32D describes right video input into H3DVARVP. Element 32E describes H3DVARVP built into mobile device for recording video.

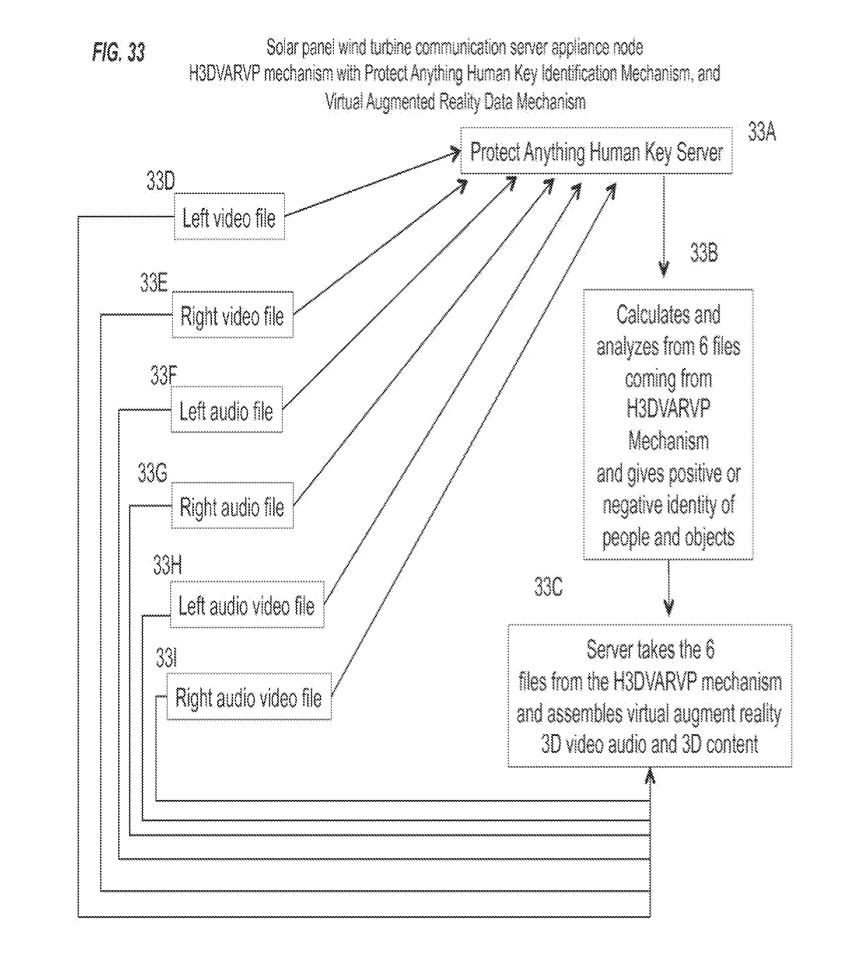

FIG. 33 describes H3DVARVP mechanism with Protect Anything Human Key Identification Mechanism, and Virtual Augmented Reality Data Mechanism. Element 33A describes H3DVARV mechanism with Protect Anything Human Key Identification Mechanism, and Solar panel wind turbine communication server appliance node network Virtual Augmented Reality Data Mechanism and shows the Protect Anything Human Key Server. Element 33B describes H3DVARV mechanism with Protect Anything Human Key Identification Mechanism, and Solar panel wind turbine communication server appliance node network Virtual Augmented Reality Data Mechanism and shows where the Protect Anything Human Key Server Calculates and analyzes from 6 files coming from H3DVARV Mechanism and gives positive or negative identity of people and objects. Element 33C describes H3DVARV mechanism with Protect Anything Human Key Identification Mechanism, and Solar panel wind turbine communication server appliance node network Virtual Augmented Reality Data Mechanism and shows the Solar panel wind turbine communication server appliance node network Server takes the 6 files from the H3DVARV mechanism and assembles virtual augment reality 3D video audio and 3D content. Element 33D describes H3DVARV mechanism with Protect Anything Human Key Identification Mechanism, and Solar panel wind turbine communication server appliance node network Virtual Augmented Reality Data Mechanism and shows the Left video file from the H3DVARV mechanism for analysis, 3D VAR creation, or 3D video creation. Element 33E describes H3DVARV mechanism with Protect Anything Human Key Identification Mechanism, and Solar panel wind turbine communication server appliance node network Virtual Augmented Reality Data Mechanism and shows the Right video file from the H3DVARV mechanism for analysis 3D VAR creation, or 3D video creation. Element 33F describes H3DVARV mechanism with Protect Anything Human Key Identification Mechanism, and Solar panel wind turbine communication server appliance node network Virtual Augmented Reality Data Mechanism and shows the Left audio file from the H3DVARV mechanism for analysis 3D VAR creation, or 3D video creation. Element 33G describes H3DVARV mechanism with Protect Anything Human Key Identification Mechanism, and Solar panel wind turbine communication server appliance node network Virtual Augmented Reality Data Mechanism and shows the Right audio file from the H3DVARV mechanism for analysis 3D VAR creation, or 3D video creation. Element 33H describes H3DVARV mechanism with Protect Anything Human Key Identification Mechanism, and Solar panel wind turbine communication server appliance node network Virtual Augmented Reality Data Mechanism and shows the Left audio plus video file combined at the Solar panel wind turbine communication server appliance node network or Protect Anything server for analysis, 3D VAR creation, or 3D video creation. Element 33I describes H3DVARV mechanism with Protect Anything Human Key Identification Mechanism, and Solar panel wind turbine communication server appliance node network Virtual Augmented Reality Data Mechanism and shows the Right audio plus video file combined at the Solar panel wind turbine communication server appliance node network or Protect Anything server for analysis, 3D VAR creation, or 3D video creation.

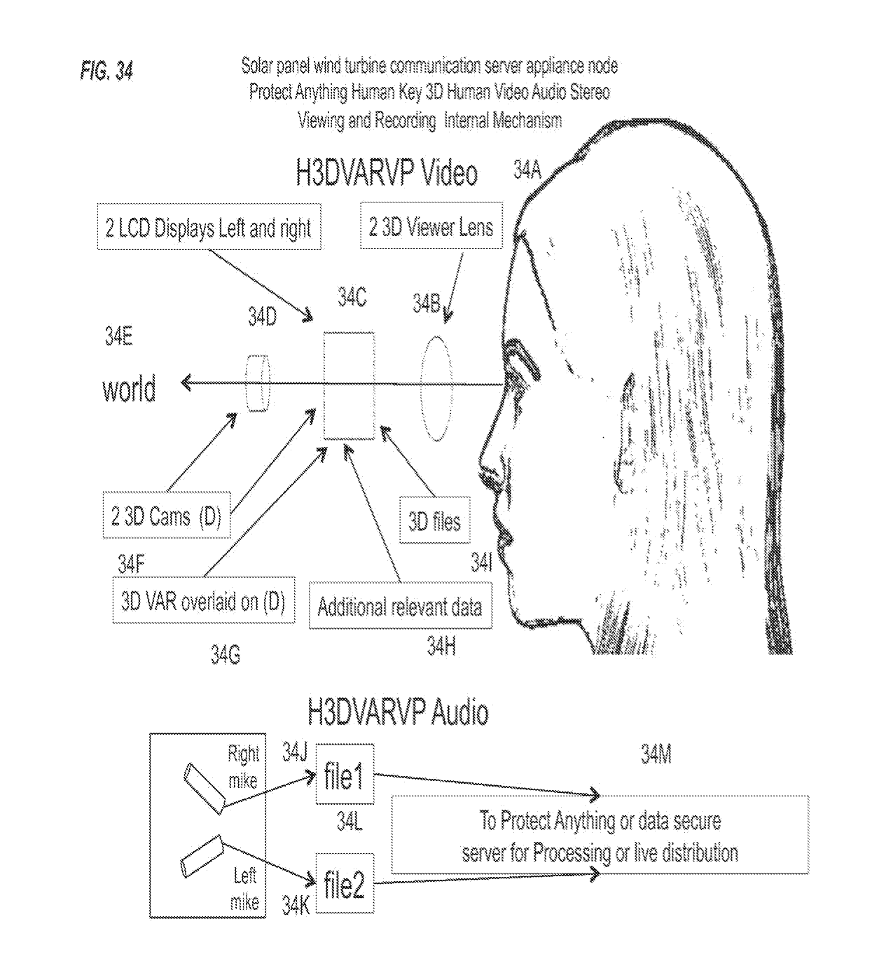

FIG. 34 describes Protect Anything Human Key 3D Human Video Audio Stereo Viewing and Recording Internal Mechanism. Element 34A describes Solar panel wind turbine communication server appliance node network Protect Anything H3DVARV 3D Human Video Audio Stereo Viewing and Recording Internal Mechanism and shows where a person looks into the lenses to view from the LCD display screen the left and right 3D view point in the H3DVARV mechanism for viewing and recording. Element 34B describes Solar panel wind turbine communication server appliance node network Protect Anything H3DVARV 3D Human Video Audio Stereo Viewing and Recording Internal Mechanism and shows the 2 3D Viewer Lens. Element 34C describes Solar panel wind turbine communication server appliance node network Protect Anything H3DVARV 3D Human Video Audio Stereo Viewing and Recording Internal Mechanism and shows the 2 LCD Displays Left and right. Element 34D describes Solar panel wind turbine communication server appliance node network Protect Anything H3DVARV 3D Human Video Audio Stereo Viewing and Recording Internal Mechanism and shows the world view from the H3DVARV device mechanism. Element 34E describes Solar panel wind turbine communication server appliance node network Protect Anything H3DVARV 3D Human Video Audio Stereo Viewing and Recording Internal Mechanism and shows the 2 3D Cams (D) that can be broadcast to the (C) LCD display screen with the viewing lens for viewing. Element 34F describes Solar panel wind turbine communication server appliance node network Protect Anything H3DVARV 3D Human Video Audio Stereo Viewing and Recording Internal Mechanism and shows the 3D VAR overlaid on (D) that can be broadcast to the (C) LCD display screen with the viewing lens for viewing. Element 34G describes Solar panel wind turbine communication server appliance node network Protect Anything H3DVARV 3D Human Video Audio Stereo Viewing and Recording Internal Mechanism and shows the Solar panel wind turbine communication server appliance node network that can be broadcast to the (C) LCD display screen with the viewing lens for viewing. Element 34H describes Solar panel wind turbine communication server appliance node network Protect Anything H3DVARV 3D Human Video Audio Stereo Viewing and Recording Internal Mechanism and shows the 3D files that can be broadcast to the (C) LCD display screen with the viewing lens for viewing. Element 34I describes Solar panel wind turbine communication server appliance node network Protect Anything H3DVARV 3D Human Video Audio Stereo Viewing and Recording Internal Mechanism and shows the right mike that is 3D stereo. Element 34J describes Solar panel wind turbine communication server appliance node network Protect Anything H3DVARV 3D Human Video Audio Stereo Viewing and Recording Internal Mechanism and shows the left mike that is 3D stereo. Element 34K describes Solar panel wind turbine communication server appliance node network Protect Anything H3DVARV 3D Human Video Audio Stereo Viewing and Recording Internal Mechanism and shows the right mike that is 3D stereo being stored in file 1 and a left mike that is 3D stereo being stored in file 2. Element 34L describes Solar panel wind turbine communication server appliance node network Protect Anything H3DVARV 3D Human Video Audio Stereo Viewing and Recording Internal Mechanism and shows the right mike that is 3D stereo, being stored in file 1, and a left mike that is 3D stereo, being stored in file 2, and both files being utilized for Protect Anything or Solar panel wind turbine communication server appliance node network secure server processing or live distribution. Element 34M describes solar panel wind turbine communication server appliance node network Protect Anything H3DVARV 3D Human Video Audio Stereo Viewing and Recording Internal Mechanism and shows where the aggregated audio from the 3D stereo microphones is streamed to Protect Anything or Solar panel wind turbine communication server appliance node network secure servers for processing or live distribution.

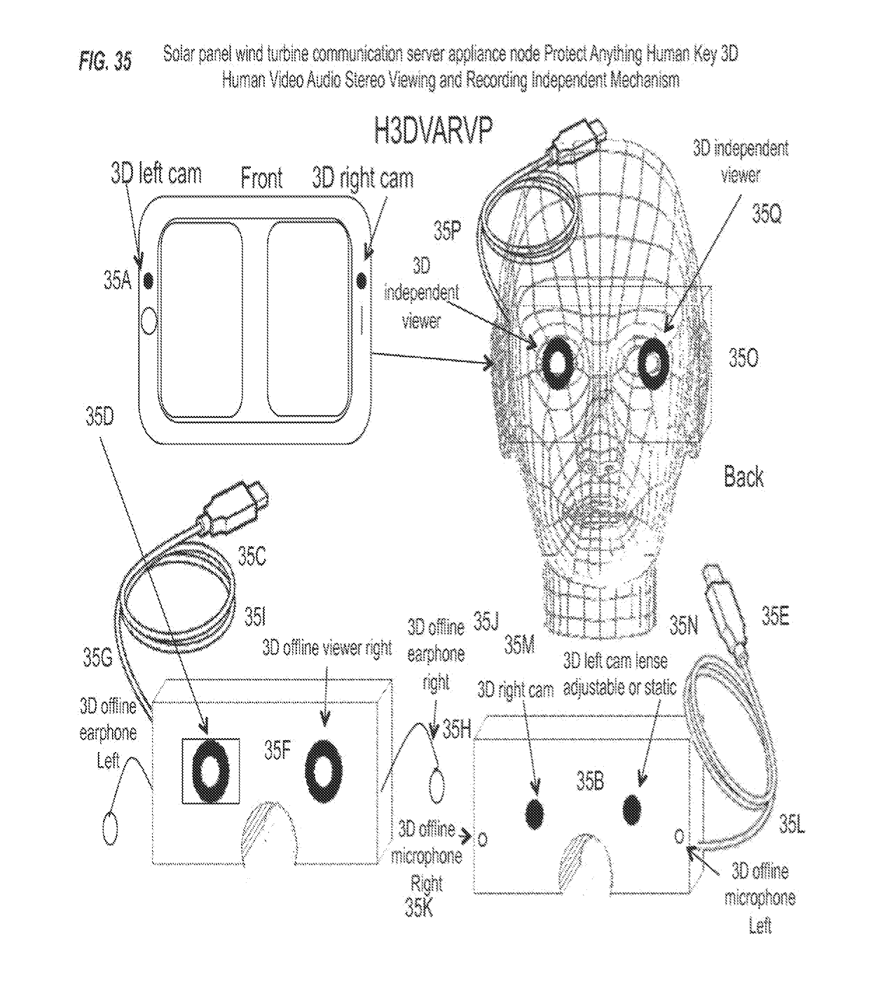

FIG. 35 describes Protect Anything Human Key 3D Human Video Audio Stereo Viewing and Recording Independent Mechanism. Element 35A describes Solar panel wind turbine communication server appliance node network Protect Anything H3DVARV 3D Human Video Audio Stereo Viewing and Recording Independent Mechanism and shows the world is 3D video recorded and streamed to Protect Anything Human Key server for sign up or sign in or to Solar panel wind turbine communication server appliance node network for 3D Video creation or 3D internal creation a front view of a mobile device display screen with H3DVARV 3D left cam and 3D right cam and H3DVARV 3D left right split screen. Element 35B describes Solar panel wind turbine communication server appliance node network Protect Anything H3DVARV 3D Human Video Audio Stereo Viewing and Recording Independent Mechanism and shows the Front 3D Cam Side Independent Camera. Element 35C describes Solar panel wind turbine communication server appliance node network Protect Anything H3DVARV 3D Human Video Audio Stereo Viewing and Recording Independent Mechanism and shows the USB cable for connecting to devices or can be used with wireless connection to mobile devices, computers and laptops. Element 35D describes Solar panel wind turbine communication server appliance node network Protect Anything H3DVARV 3D Human Video Audio Stereo Viewing and Recording Independent Mechanism and shows the movable adjustable independent viewer lenses left right up down. Element 35E describes Solar panel wind turbine communication server appliance node network Protect Anything H3DVARV 3D Human Video Audio Stereo Viewing and Recording Independent Mechanism and shows the USB connector. Element 35F describes Solar panel wind turbine communication server appliance node network Protect Anything H3DVARV 3D Human Video Audio Stereo Viewing and Recording Independent Mechanism and shows the Back 3D Viewer Side Independent Camera. Element 35G describes Solar panel wind turbine communication server appliance node network Protect Anything H3DVARV 3D Human Video Audio Stereo Viewing and Recording Independent Mechanism and shows 3D offline earphone Left. Element 35H describes Solar panel wind turbine communication server appliance node network Protect Anything H3DVARV 3D Human Video Audio Stereo Viewing and Recording Independent Mechanism and shows 3D offline earphone Right. Element 35I describes Solar panel wind turbine communication server appliance node network Protect Anything H3DVARV 3D Human Video Audio Stereo Viewing and Recording Independent Mechanism and shows the 3D offline viewer right. Element 35J describes Solar panel wind turbine communication server appliance node network Protect Anything H3DVARV 3D Human Video Audio Stereo Viewing and Recording Independent Mechanism and shows the 3D offline earphone right. Element 35K describes Solar panel wind turbine communication server appliance node network Protect Anything H3DVARV 3D Human Video Audio Stereo Viewing and Recording Independent Mechanism and shows the 3D offline microphone Right. Element 35L describes Solar panel wind turbine communication server appliance node network Protect Anything H3DVARV 3D Human Video Audio Stereo Viewing and Recording Independent Mechanism and shows 3D offline microphone Left. Element 35M describes Solar panel wind turbine communication server appliance node network Protect Anything H3DVARV 3D Human Video Audio Stereo Viewing and Recording Independent Mechanism and shows the 3D right cam. Element 35N describes Solar panel wind turbine communication server appliance node network Protect Anything H3DVARV 3D Human Video Audio Stereo Viewing and Recording Independent Mechanism and shows the 3D left cam lenses adjustable or static. Element 35O describes Solar panel wind turbine communication server appliance node network Protect Anything H3DVARV 3D Human Video Audio Stereo Viewing and Recording Independent Mechanism and shows how the mechanism includes the independent H3DVARV device that can be goggles, are titanium light weight glasses for viewing and recording 3D video and 3D audio. Element 35P describes Solar panel wind turbine communication server appliance node network Protect Anything H3DVARV 3D Human Video Audio Stereo Viewing and Recording Independent Mechanism and shows the 3D independent viewer. Element 35Q describes Solar panel wind turbine communication server appliance node network Protect Anything H3DVARV 3D Human Video Audio Stereo Viewing and Recording Independent Mechanism and shows the 3D independent viewer.

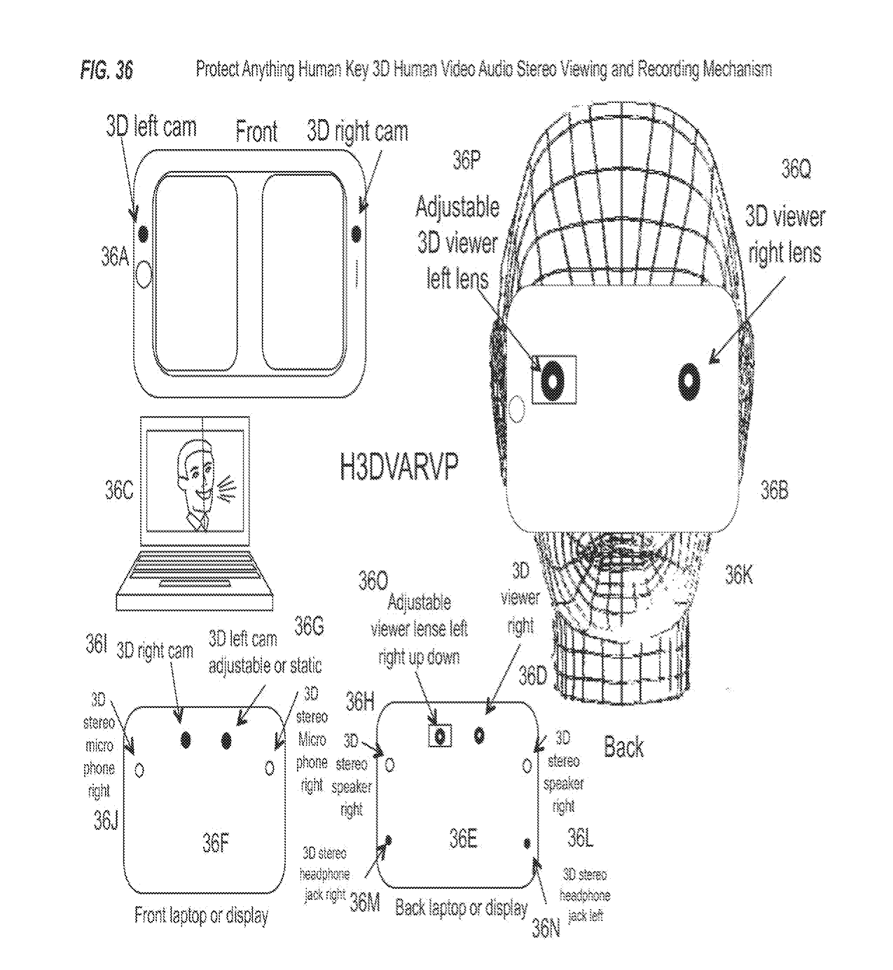

FIG. 36 describes Protect Anything Human Key 3D Human Video Audio Stereo Viewing and Recording Mechanism. Element 36A describes Solar panel wind turbine communication server appliance node network Protect Anything H3DVARV 3D Human Video Audio Stereo Viewing and Recording Mechanism and shows the world is 3D video recorded and streamed to Protect Anything Human Key server for sign up or sign in or to Solar panel wind turbine communication server appliance node network for 3D Video creation or 3D internal creation a front view of a mobile device display screen with H3DVARV 3D left cam and 3D right cam and H3DVARV 3D left right split screen. Element 36B describes Solar panel wind turbine communication server appliance node network Protect Anything H3DVARV 3D Human Video Audio Stereo Viewing and Recording Mechanism and shows a mobile phone or device with H3DVARV viewing lenses to view through mechanism. Element 36C describes Solar panel wind turbine communication server appliance node network Protect Anything H3DVARV 3D Human Video Audio Stereo Viewing and Recording Mechanism and shows a laptop with Protect Anything Human Key sign in registration utilizing the H3DVARV 3D Viewing recording mechanism. Element 36D describes Solar panel wind turbine communication server appliance node network Protect Anything H3DVARV 3D Human Video Audio Stereo Viewing and Recording Mechanism and shows the back of a laptop or display for viewing through the H3DVARV mechanism with the 3D viewer right mechanism. Element 36E describes Solar panel wind turbine communication server appliance node network Protect Anything H3DVARV 3D Human Video Audio Stereo Viewing and Recording Mechanism and shows the laptop configured with the H3DVARV mechanism for viewing and recording video audio. Element 36F describes Solar panel wind turbine communication server appliance node network Protect Anything H3DVARV 3D Human Video Audio Stereo Viewing and Recording Mechanism and shows the front laptop display with the H3DVARV mechanism for 3D cams and 3D stereo microphones for recording. Element 36G describes Solar panel wind turbine communication server appliance node network Protect Anything H3DVARV 3D Human Video Audio Stereo Viewing and Recording Mechanism and shows the 3D left cam adjustable or static. Element 36H describes Solar panel wind turbine communication server appliance node network Protect Anything H3DVARV 3D Human Video Audio Stereo Viewing and Recording Mechanism and shows the 3D stereo speaker right. Element 36I describes Solar panel wind turbine communication server appliance node network Protect Anything H3DVARV 3D Human Video Audio Stereo Viewing and Recording Mechanism and shows the 3D right cam. Element 36J describes Solar panel wind turbine communication server appliance node network Protect Anything H3DVARV 3D Human Video Audio Stereo Viewing and Recording Mechanism and shows the 3D stereo microphone right. Element 36K describes Solar panel wind turbine communication server appliance node network Protect Anything H3DVARV 3D Human Video Audio Stereo Viewing and Recording Mechanism and shows Element 36L describes Solar panel wind turbine communication server appliance node network Protect Anything H3DVARV 3D Human Video Audio Stereo Viewing and Recording Mechanism and shows the 3D stereo speaker right. Element 36M describes Solar panel wind turbine communication server appliance node network Protect Anything H3DVARV 3D Human Video Audio Stereo Viewing and Recording Mechanism and shows the 3D stereo headphone jack right. Element 36N describes Solar panel wind turbine communication server appliance node network Protect Anything H3DVARV 3D Human Video Audio Stereo Viewing and Recording Mechanism and shows the 3D stereo headphone jack left. Element 360 describes Solar panel wind turbine communication server appliance node network Protect Anything H3DVARV 3D Human Video Audio Stereo Viewing and Recording Mechanism and shows the Adjustable viewer lenses left right up down. Element 36P describes Solar panel wind turbine communication server appliance node network Protect Anything H3DVARV 3D Human Video Audio Stereo Viewing and Recording Mechanism and shows the Adjustable 3D viewer left lens. Element 36Q describes Solar panel wind turbine communication server appliance node network Protect Anything H3DVARV 3D Human Video Audio Stereo Viewing and Recording Mechanism and shows the 3D viewer right lens.

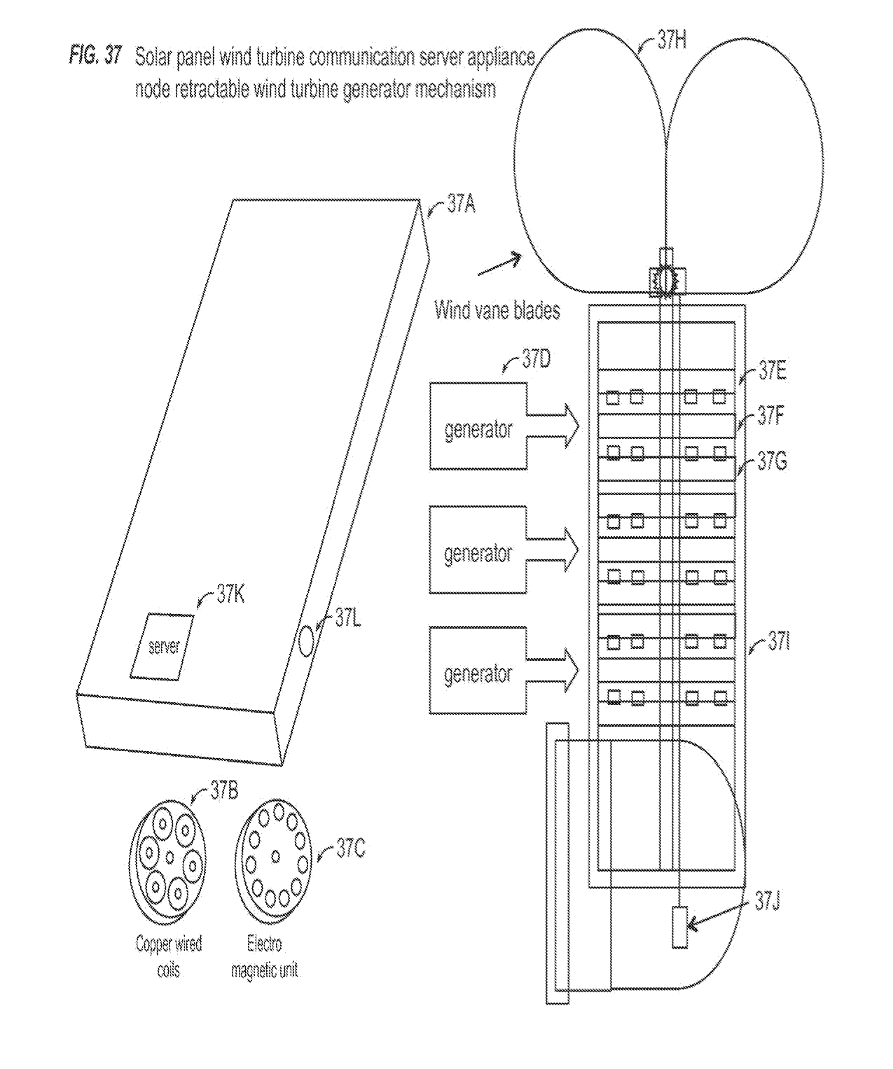

FIG. 37 is a conceptual diagram illustrating a method and mechanism that shows solar panel wind turbine communication server appliance node retractable wind turbine generator mechanism. Element 37A is a conceptual diagram illustrating a method and mechanism that shows solar panel wind turbine communication server appliance node mechanism. Element 37B is a conceptual diagram illustrating a method and mechanism that shows stator copper wired coils generator mechanism. Element 37C is a conceptual diagram illustrating a method and mechanism that shows the electromagnetic or non-electromagnetic magnet unit rotor generator mechanism. Element 370 is a conceptual diagram illustrating a method and mechanism that shows the multiple generators encased in the wind turbine shaft. Element 37E is a conceptual diagram illustrating a method and mechanism that shows the top magnetic rotor for the generator mechanism. Element 37F is a conceptual diagram illustrating a method and mechanism that shows the middle stator coils mechanism of the generator mechanism. Element 37G is a conceptual diagram illustrating a method and mechanism that shows the bottom magnetic rotor for the generator mechanism. Element 37H is a conceptual diagram illustrating a method and mechanism that shows the wind vane mechanism that folds into ball or oval egg shape for storage, and opens for use and spinning the magnetic rotors in the wind turbine. Element 37I is a conceptual diagram illustrating a method and mechanism that shows the thermal cooling area, and wiring collar area for wires to go into the main solar panel wind turbine communication server appliance node mechanism box. Element 37J is a conceptual diagram illustrating a method and mechanism that shows the servo for raising and lowering the wind vanes connected to the gears on the wind vane assembly. Element 37K is a conceptual diagram illustrating a method and mechanism that shows the control server that links to sensing information for decisions about opening or closing the wind vane assembly for protection and wind generation of electricity in the mechanism. Element 37L is a conceptual diagram illustrating a method and mechanism that shows the input area that is waterproof and sealed for the connector to the wind turbine generator mechanism.

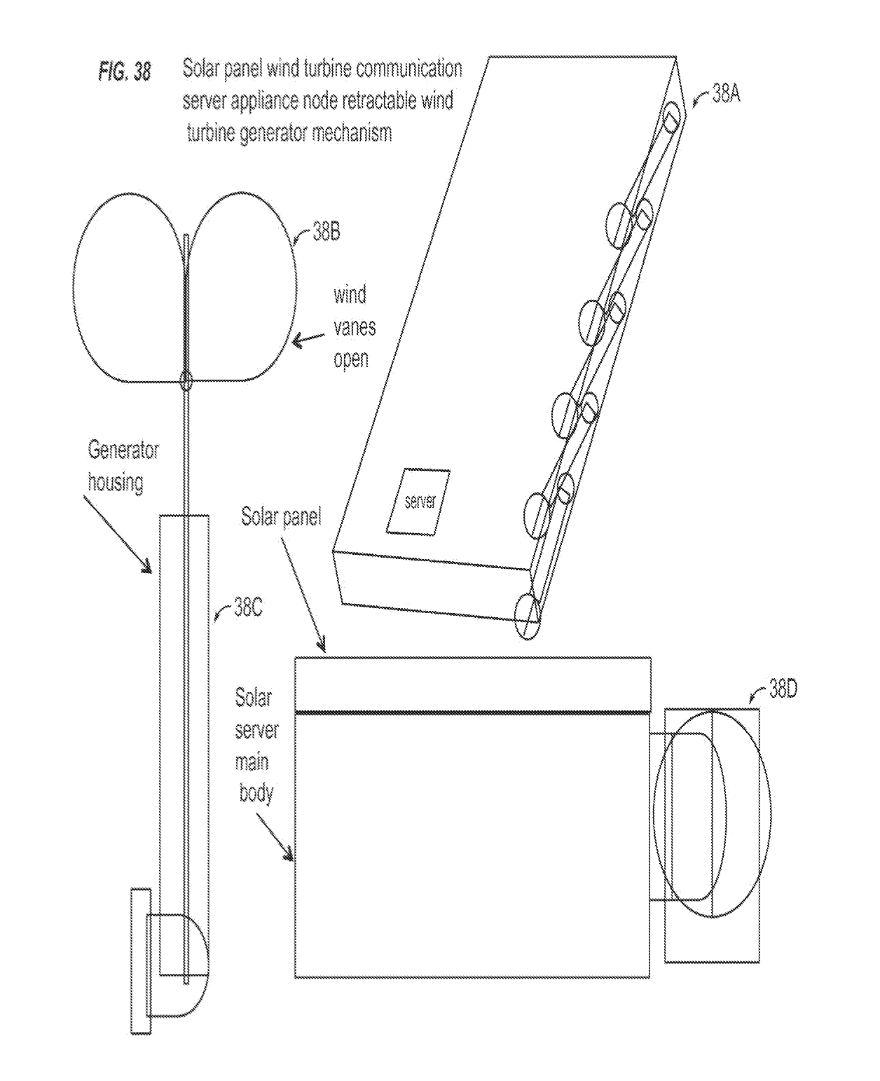

FIG. 38 is a conceptual diagram illustrating a method and mechanism that shows solar panel wind turbine communication server appliance node retractable wind turbine generator mechanism. Element 38A is a conceptual diagram illustrating a method and mechanism that shows closed retracted and stored wind turbine vane blades in a ball or egg shape reducing wind resistance. Element 38B is a conceptual diagram illustrating a method and mechanism that shows wind vanes open for electricity generation. Element 38C is a conceptual diagram illustrating a method and mechanism that shows the generator housing shaft mechanism where the multiple generator disks are protected from dust and moisture in the mechanism. Element 38D is a conceptual diagram illustrating a method and mechanism that shows retracted wind turbine vane blades in storage protected position attached on the mechanism.

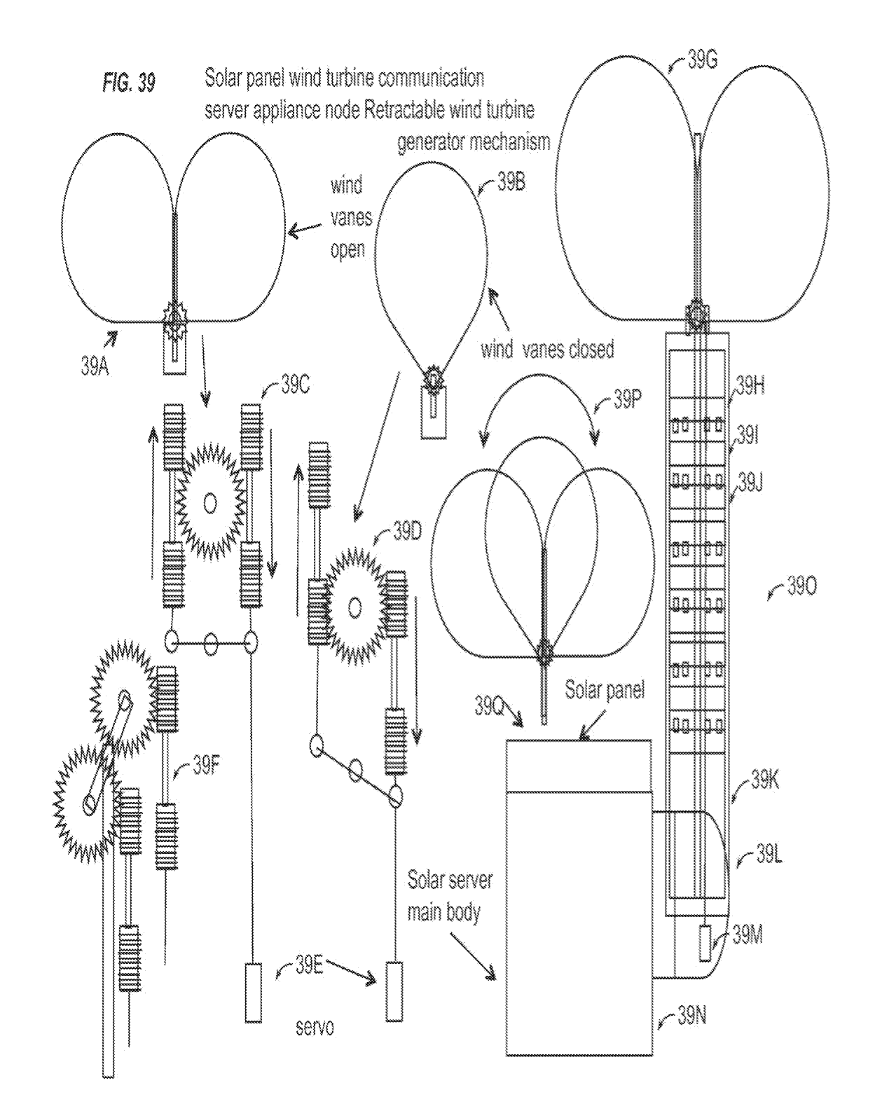

FIG. 39 is a conceptual diagram illustrating a method and mechanism that shows solar panel wind turbine communication server appliance node retractable wind turbine generator mechanism. Element 39A is a conceptual diagram illustrating a method and mechanism that shows the wind turbine generator mechanism wind vanes open mechanism. Element 39B is a conceptual diagram illustrating a method and mechanism that shows wind turbine generator mechanism wind vanes closed mechanism. Element 39C is a conceptual diagram illustrating a method and mechanism that shows the gear movement mechanism for the opening of the wind vanes in the wind turbine generator mechanism utilizing the servo managed by the solar main server manager. Element 390 is a conceptual diagram illustrating a method and mechanism that shows the gear movement mechanism for the closing of the wind vanes in the wind turbine generator mechanism utilizing the servo managed by the solar main server manager. Element 39E is a conceptual diagram illustrating a method and mechanism that shows the servo that controls the opening and closing of the wind vanes. Element 39F is a conceptual diagram illustrating a method and mechanism that shows the shaft connected to the gear system of the wind vane with the gear system that creates non friction use mode. Element 39G is a conceptual diagram illustrating a method and mechanism that shows wind vanes in generation mode. Element 39H is a conceptual diagram illustrating a method and mechanism that shows magnetic top rotors of the wind turbine. Element 39I is a conceptual diagram illustrating a method and mechanism that shows magnetic coils stator middle rotors of the wind turbine. Element 39J is a conceptual diagram illustrating a method and mechanism that shows magnetic bottom rotors of the wind turbine. Element 39K is a conceptual diagram illustrating a method and mechanism that shows the air thermal sensing area and ventilation cooling area of the wind turbine main housing shaft. Element 39L is a conceptual diagram illustrating a method and mechanism that shows the connector area connected to the solar panel wind turbine communication server appliance node mechanism. Element 39M is a conceptual diagram illustrating a method and mechanism that shows servo for closing and opening wind vane. Element 39N is a conceptual diagram illustrating a method and mechanism that shows the solar server main body where the lowering and raising servo is located for lowering and raising the wind vane mechanism. Element 39O is a conceptual diagram illustrating a method and mechanism that shows the wind vane turbine shaft and mechanism. Element 39P is a conceptual diagram illustrating a method and mechanism that shows where the wind vanes retract to an egg shape or ball shape for wind or other protection of the wind vane system and mechanism. Element 39Q is a conceptual diagram illustrating a method and mechanism that shows the solar panel of the solar panel wind turbine communication server appliance node mechanism.

Moreover, other implementations of the invention will be apparent to those skilled in the art from consideration of the specification and practice of the invention disclosed herein. Various aspects and/or components of the described embodiments may be used individually or in any combination in the computerized content filtering system. It is intended that the specification and examples be considered as exemplary only, with a true scope and spirit of the invention being indicated by the following claims.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A solar panel and wind turbine hybrid apparatus in combination with a computer server, comprising in combination:
one or more solar panels and one or more wind turbines for generating electrical energy;
a computer server connected to the solar panels and wind turbines for the purpose of creating, processing, serving, managing, storing, maximizing, and monetizing the electrical generation;
an appliance providing voice over internet protocol (VOIP) cell connection connected to the computer server connected to the solar panels and wind turbines;
the appliance is accessed using a human key identification for authentication and protecting access to the computer server connected to the solar panels and wind turbines;
a cooling system manager;
a thermal sensor;
servers controlling management for use with conventional power and communication grid or independently off the conventional power and communication grid;
a KWH hour metering manager connected to the solar panels and wind turbines for metering and storing BTU energy and KWH hour energy that is managed and distributed through a solar wind parallel processing node system and is monetized through a link to a KWH hour bank that can store, process, transfer and transact legal currencies and or issued credits;
a KWH energy bank which permits users to participate in the excess revenue generated from energy delivered electronic metering system for determining and storing information related to KWH in and KWH out;
an energy management module where any excessive energy is sold to the conventional grid or deposited in the KWH hour bank at current market rates providing each authorized owner with cash or legal currency payments or credits deposited or withdrawn to and from their KWH bank account after management fees are deducted;
a KWH hour banking manager connected to the solar panels and wind turbines providing:
deposit and conversion of electricity to currency tracking;
tracking and monitoring information about the use and efficiency and amounts deposited into their KWH hour bank account as cash or lawful currencies, or credits metering of the BTU thermal units, KWH hours and transactions between the network and a KWH energy bank;
a portable battery storage metering and manager server providing the ability to store, transport, and portably transfer electricity;
a NFC RFID wireless communication module;
a USB wired communication module;
a display mounted onto the battery for managing data;
a human key security module providing audio voice phrase and human facial live video identification;
an ATM for emptying stored portable electricity and getting instant payment; and
each of the solar servers is installed at a specific spatial point target, utilizing multiple spatial points for remote identification of the location, position and security identification tracking and analysis, of each solar server and diagnostic purposes, and is connected to the KWH hour energy bank for security identification, for delivery of transactions information, data, video, music, audio, and entertainment

2. The apparatus of claim 1, further comprising in combination:
a human key module for identifying human beings utilizing video from remote locations processed in a plurality of servers for instant identification of humans with facial, voice and input data;
the human key module performing a test of the human spoken phrase as a pin phrase through a voice recognition module, to arrive at a recognized phrase implemented into a database and used to search for any other users phrases that match the actual words and order of the words, and then the module automatically places the group of identical phrases into an array for further processing;
a speaker recognition module that starts processing with the specific point of phrase being spoken to calculate similarities in the Fourier wave patterns to enroll the patterns for later comparison to recognize the speaker;
audio video human facial recognition components and processes for identification, verification and certification of humans; and
a bin-aural cam and audio system with thermal sensors, and infrared distance sensors for spatial calculations and evaluations, and heat analysis with plug-in connectors for all five human senses detecting processors to authenticate and prevent non-human intrusion into the module.

3. The apparatus of claim 2, further comprising in combination:
a belt apparatus for sensing all five human senses;
one or more gaseous, thermal, optical, pressure, and weather sensors at specific spatial points and remotely from any networked wired or wireless device that is connected to a server for the purpose of monitoring, and tracking and providing useful information and data via VOIP, with video;
a search engine that aggregates, stores, and indexes data related to the five human senses;
a reasoning engine module combined with visual, audio, chemical analysis for smell and taste evaluation, and thermal motion sensor and video, audio, image, senses, or reasoning data is presented and delivered to a mobile device, wireless or wired device, artificial human machine, or robot; and
a lateral thinking module for assisting members of the solar panel wind turbine communication server appliance node network with creative, social, and purchasing decisions from within the learned knowledge base of the whole network.

4. The apparatus of claim 1, further comprising in combination:
a magnetic motor generator for generating additional energy to the solar panel wind turbine communication server appliance node cluster grid.

5. The apparatus of claim 1, further comprising in combination:
a camera that can be a stand alone or embedded in any wireless hand held device, including mobile phones or wired devices, combined with projector and 3D glasses, for recording video, and audio streaming images;
a module connected to the solar panel wind turbine communication server appliance node user space for reflecting screen projection onto objects, or from a handheld device on to wall or any reflected surface, and further comprising stand alone projection in a free space, connected to the solar panel wind turbine communication server appliance node network, wired or wirelessly including mobile devices.
playing or projecting pre recorded or live video, and projecting 3D video prerecorded or live transmitted at any specified spatial or non-spatial point and projected onto any wall, floor, ceiling, glass or reflected surface with the solar panel wind turbine communication server appliance node network module for spatial point targeting calibrated to the solar panel wind turbine communication server appliance nodes;
a storage and sharing module.

6. The apparatus of claim 1, further comprising in combination:
a human semantic personality development module for aggregation of individual and groups of decisions made over a set period of time, utilizing natural, genetic, environmental, factors including preferences, and analysis, values, beliefs, expectations, as part of a personality creation module;
the a personality creation module adding additional relevant learned information about a person and or personality as time goes by, and the ability to turn back a personality to a previous or different time frame;
the ability to learn, teach, or train a personality for a more perfect human user members personality;
the ability to transfer a personality to smart devices, robots, mechanical devices and machines, including wireless devices for use in the solar panel wind turbine communication server appliance node network;
a means to view another person's personality utilizing hardware and software that can be licensed, leased or purchased, and furthermore comprising the ability to exchange, trade, or merge personalities in machines, robots or smart modules, including gaming;
a blog, entertainment, news, financial, social reporter module as related to the solar panel wind turbine communication server appliance node network to deliver relevant trusted information relating to what a user is interested in, to wired and wireless devices; and
a wildcard reporter module for information related to lateral thinking suggestions related to user members personality in the system, and further comprising an advertising network module related to the evolving personality of the user in the solar panel wind turbine communication server appliance node network, and the module has the ability to change as the personality changes for better more relevant advertising suggestions throughout the present invention.

7. The apparatus of claim 1, further comprising in combination:
a module for distance transmissions;
a network of solar panel wind turbine communication server appliance node clusters with information and storage areas for each unique user or group of users;
each cluster array of solar panel wind turbine communication server appliance node functions as a decision, requests, suggestions, and reminder module, for use by smart modules, mobile devices and robots;
any space can be used as a communication spot by converting those spaces to spatial or non spatial point targets;
each communication area or space can allow communication by voice activation from one spatial point to another or group of spatial points to another, and furthermore comprising each communication area can have a cylindrical zone with video or 3D video;
a packet delivery module for video, audio, text and data, to and from the solar panel wind turbine communication server appliance node;
a wireless video cam, music mixer, backup device, sound recorder accessible with wired or wireless devices including mobile phones for recording and storage of data in the solar panel wind turbine communication server appliance node connected to any accessible or non accessible free standing space.

8. The apparatus of claim 1, further comprising in combination:
the KWH hour bank and payment system is connected and agrees to stay connected to the solar panel wind turbine communication server appliance node network;
a module for turning surplus KWH hour energy from a location to any legal currency or virtual currency that can be used as credits and debits for the purchases of goods and services;
a module for issuing debit and credit cards through a KWH hour bank;
a module for connecting KWH hour credits and debits to be shown and used on an ATM machine that is connected to the solar panel wind turbine communication server appliance node;
creating mortgages and loans that are secured by the energy created from a wind turbine communication server appliance network location or group of locations; and
an automated billing management module for processing, accounting, and payment information, automatic aggregation and metering of KWH hour purchases, payments, and credits for processing, calculating, and tabulating energy usage that is derived from a solar panel wind turbine communication server appliance node network.

9. The apparatus of claim 1, further comprising in combination:
an automatic payment module for any product, goods, or services that has RFID tags or bar codes so that an automatic payment can be made as a person walks by or comes in contact with a product, sale, lease or purchase able item;
a module that turns an RFID tag or bar code into a point of purchase advertisement, demonstration, or tutorial using video, audio, text, and data; and
any of the features are shown on any surface that is connected to the solar panel wind turbine communication server appliance node network and used on any connected device.

10. The apparatus of claim 1, further comprising in combination:
an independent wind turbine electricity generator module that can connect to a surface, with a built in wind turbine server manager;
a plurality of multiple generators or machines that convert mechanical energy into electrical energy for multiple electricity generation assembled into one assembly or multiple assemblies on a shaft connected to a servo adjustable wind vane, for open position while generating electricity;
a closed ball position for storage and inclement weather protection, with wires for transmission of electricity going down the double insulated shaft into the surface that it is mounted to, or with wireless for transmission electricity to a separate place for use or storage or a nearby collector with a seal for moisture protection;
a low energy ventilator, and thermal gaseous sensor built into the multiple wind turbines attached to separate controller for measuring and keeping turbine shaft at optimum temperature;
internal sensing devices for decisions to raise the wind turbine, or lower the wind turbine for storage to be out of the way, at different times of the day or night or storage for protection of the wind turbines during high winds or inclement weather, and raised for the generation of electricity utilizing wind; and
one or more servos built into the independent wind turbine module that controls automatic storage and use position for the independent wind turbine module wind turbines that is controlled by the group of microcontrollers servers built into the wind turbine module, that is connected to information related to weather, and internal sensing devices for decisions to raise the wind turbine, or lower the wind turbine for storage to be out of the way, at different times of the day or night or storage for protection of the wind turbines during high winds or inclement weather, and raised for the generation of electricity utilizing wind.

11. The apparatus of claim 6, further comprising in combination:
a mobile or virtual avatar and or agent connected to a user personality that understands a users preferences, likes, and dislikes;
the avatar and or agent has the exact users measurements and can shop for products and services for ideal fits and best prices online or at stores locations, and demonstrate how those products look on a users 3D mannequin, or avatar and or agent; and
a module with and without virtual avatars and or agents for bringing 3D shopping experiences to any designated location, place or thing that is connected to the solar panel wind turbine communication server appliance.

12. The apparatus of claim 1, further comprising in combination:
An audio infrared radio wave transmitter to a spatial point target zones including to mechanical or human ear receiver;
an infrared laser sound module that converts infrared light waves to audio sound waves at a zone of a specific spatial point or groups of spatial points; and
an infrared or light laser conversion of specific light wave to specific sound wave at specific spatial point and non spatial point targets.

13. The apparatus of claim 1, further comprising in combination:
a group of low level lasers, utilizing colors, and intensity, where laser targets are determined specifically by spatial points calibrated to solar panel wind turbine communication server appliance nodes for positioning, to create free positioned, reflections and refractions from combinations of laser points, producing brilliant red green and blue points of light in a predetermined pattern of images, and video, text in free space;
a mini multiple laser beam projector with multiple laser diode specific targeting module with calibrations to the solar panel wind turbine communication server appliance node cluster module, for precise intensity, and brilliant color created spatial point targeted light points for video, audio, and image text projection in a free space; and
a module for audio to spatial point target cylinder or any shape, so as you walk into or sit in a chair within the cylinder zone area the audio, video, can only be heard within that cylinder zone area space and not outside that zone space.

14. The apparatus of claim 1, further comprising in combination:
the solar panel wind turbine communication server appliance node combined with an outdoor or indoor advertising digital, LED, and or electronic rotational advertising billboard, with microprocessors and storage; and
a module for projecting messages to any open air space or surface using streaming audio, and video including rotational ads and messages to a specific spatial or non-spatial point target that is connected to a solar panel wind turbine communication server appliance node or in proximity to one.

15. The apparatus of claim 1, further comprising in combination:
the solar panel wind turbine communication server appliance node parallel central processing units for processing, sensing, and reasoning information;
transmitting and receiving multimedia content at enhanced speeds to spatial and non spatial distribution points and information channels;
a plurality of processing nodes for superior performance and enhancement of multimedia entertainment;
voice activation to wired or wireless devices, utilizing a cluster of server nodes in a parallel state;
accessing information directories that may be downloaded from a global computer network, into the solar panel wind turbine communication server appliance node network for sharing;
a human key for identifying the proper owner of content delivered in the network platform;
a module to store files on independent solar panel wind turbine communication server appliance node network and multiple nodes;
a module making all files available to all the network solar panel wind turbine communication server appliance nodes, and wireless connections to local users in the proximity of the solar panel wind turbine communication server appliance nodes;
a module for the control of voice controlled information and communication devices; and
a management systems for advertising, communications, and power supply management, with identification and verification with voice controlled systems, keyword filing systems.

16. The apparatus of claim 1, further comprising in combination:
the solar panel wind turbine communication server appliance nodes cannot be opened without authorization through the built in human key audio video binaural cam module, without instantly deleting or encrypting all data in the nodes that are opened; and
automatically sending improper an entry alert to the proper authorities

17. The apparatus of claim 1, further comprising in combination:
multiple wind turbine units are used that are built into and externally located on each solar server unit and networked solar server parallel processing grid;
utilizing wireless, and wired electricity and/or energy, to and from each solar panel wind turbine communication server appliance node for additional energy generation;
a wind turbine module with a plurality of multiple generators or machines that convert mechanical energy into electrical energy for multiple electricity generation assembled into one assembly or multiple assemblies on a shaft connected to a servo adjustable wind vane, for open position while generating electricity;
a closed ball position for storage and inclement weather protection, with wires for transmission of electricity going down the double insulated shaft into the solar panel wind turbine communication server appliance node or with wireless for transmission electricity to the main box or nearby collector with a seal for moisture protection.

18. The apparatus of claim 1, further comprising in combination:
a battery management module controlled by a battery manager server in the solar panel wind turbine communication server appliance node array, for distilled water levels management, and power consumption management;
the battery management module sending and receiving information involving temperature, security, maintenance and water management of the battery cluster or portable battery as well as aggregate and control load balancing from the battery cluster and solar panel wind turbine communication server appliance node network to the grids;
a dual purpose electrical socket for splitting the conventional power grid supply from the solar panel wind turbine communication server appliance node grid supply; and
an automatic switching module between the two grids;
energy need is determined by the solar panel wind turbine communication server appliance node management main server; and
when the energy that is created from the solar panel apparatus is not enough for the need, the automatic switch converts to the conventional power grid until the need determination decrease to a level that can be supported by the solar panel apparatus

19. The apparatus of claim 1, further comprising in combination:
the wind turbine module with a plurality of multiple generators or machines that convert mechanical energy into electrical energy for multiple electricity generation assembled into one assembly or multiple assemblies on a shaft connected to a servo adjustable wind vane, for open position while generating electricity;
a closed ball position for storage and inclement weather protection, with wires for transmission of electricity going down the double insulated shaft into the solar panel wind turbine communication server appliance node or with wireless for transmission electricity to the main box or nearby collector with a seal for moisture protection;
a servo built into the solar panel wind turbine communication server appliance node that controls automatic storage and use position for the solar panel wind turbine communication server appliance node wind turbines that is controlled by a group of microcontrollers in the main server unit, and that is connected to information related to weather, and internal sensing devices for decisions to raise the wind turbines, or lower the wind turbines for storage to be out of the way, and not blocking light with shadows on solar panels at different times of the day or night or storage for protection of the wind turbines during high winds or inclement weather, and raised for the generation of electricity utilizing wind; and
a multiple gear, single lever, single shaft pull system that automatically converts the wind vanes into a round or oval shaped ball for storage and protection, pulled by a servo that either opens or closes the wind vanes for use or storage, that is connected into a retraction module and managed by the main server, with wind speed, senses of temperature, gaseous analysis, and weather information for decisions to retract or raise the wind vanes for energy creation or storage for protection from inclement weather.
